(19) United States
(12) Patent Application Publication
(10) Pub. No.: US 2026/0074746 A1
(43) Pub. Date: Mar. 12, 2026

(54) PHASE CONTINUITY ASSOCIATED WITH RECONFIGURABLE INTELLIGENT SURFACES

(71) Applicant: QUALCOMM Incorporated, San Diego, CA (US)

(72) Inventors: Ahmed ELSHAFIE, San Diego, CA (US); Hung Dinh LY, San Diego, CA (US); Seyedkianoush HOSSEINI, San Diego, CA (US); Yu ZHANG, San Diego, CA (US)

(21) Appl. No.: 18/869,739

(22) PCT Filed: Aug. 4, 2022
(86) PCT No.: PCT/CN2022/110217

§ 371 Date: Nov. 26, 2024

(51) Int. Cl. H04B 7/04; H04W 8/22; H04W 76/20; H04W 92/18

(52) U.S. Cl. CPC H04B 7/04013; H04W 8/22; H04W 76/20; H04W 92/18

(57) ABSTRACT

Methods, systems, and devices for wireless communications are described. A reconfigurable intelligent surface (RIS) may indicate an ability to maintain phase continuity across transmissions. The RIS may transmit a capability information message and receive control signaling indicating one or more conditions under which the RIS may maintain phase continuity. For example, the RIS may maintain phase continuity when the separation time between consecutive transmissions may be long enough for the RIS to change to an original configuration or original set of transmission parameters. In other cases, the RIS may maintain phase continuity when the same configuration or set of transmission parameters are used between consecutive transmissions, and the time between the transmissions does not exceed a threshold. The RIS may relay signals based on the one or more conditions.

### CROSS REFERENCE

The present Application is a 371 national phase filing of International PCT Application No. PCT/CN2022/110217 by ELSHAFIE et al., entitled “PHASE CONTINUITY ASSOCIATED WITH RECONFIGURABLE INTELLIGENT SURFACES,” filed Aug. 4, 2022, which is assigned to the assignee hereof, and which is expressly incorporated by reference in its entirety herein.

### FIELD OF TECHNOLOGY

The following relates to wireless communications, including phase continuity associated with reconfigurable intelligent surfaces (RISs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A wireless communications system may include a reconfigurable intelligent surface (RIS). In some wireless communications systems, a wireless device (e.g., a UE or network entity) may perform bundling to leverage channel information across transmissions.

### SUMMARY

The described techniques relate to improved methods, systems, devices, and apparatuses that support phase continuity associated with reconfigurable intelligent surfaces (RISs). For example, the described techniques provide for a RIS to indicate a capability to maintain phase continuity in one or more transmissions reflected, forwarded, or otherwise redirected by the RIS. In some cases, the RIS may maintain phase continuity when the RIS uses the same configuration for reflecting transmissions from a transmitting device to a receiving device or set of transmission parameters including a same frequency resource, a same transmit power, a same spatial transmit relation, a same antenna port(s), a same precoding, or any combination thereof across transmissions. When the RIS changes configuration or changes the set of transmission parameters between transmissions, the RIS may be able to maintain phase continuity if the RIS can switch back to an original configuration or set of parameters within a threshold amount of time. In some examples, the RIS may be able to maintain phase continuity during a threshold amount of time, and may assume that phase continuity is broken for transmissions outside the threshold amount of time. A receiving wireless device may determine, based on the RIS capability reported by the RIS, whether to perform demodulation reference signal (DMRS) bundling and joint processing across transmissions (e.g., based on whether the RIS is able to maintain phase continuity across transmissions).

A method for wireless communications at a reflective surface is described.

The method may include transmitting capability information indicating a capability to maintain phase continuity across a set of multiple transmissions according to a first set of transmission parameters, receiving, based on the capability information, control signaling indicating one or more conditions under which the reflective surface is to maintain phase continuity, and relaying wireless signaling between at least a first wireless device and a second wireless device according to a phase continuity condition based on the one or more conditions.

An apparatus for wireless communications at a reflective surface is described. The apparatus may include a processor, memory in electronic communication with the processor, and instructions stored in the memory. The instructions may be executable by the processor to cause the apparatus to transmit capability information indicating a capability to maintain phase continuity across a set of multiple transmissions according to a first set of transmission parameters, receive, based on the capability information, control signaling indicating one or more conditions under which the reflective surface is to maintain phase continuity, and relay wireless signaling between at least a first wireless device and a second wireless device according to a phase continuity condition based on the one or more conditions.

Another apparatus for wireless communications at a reflective surface is described. The apparatus may include means for transmitting capability information indicating a capability to maintain phase continuity across a set of multiple transmissions according to a first set of transmission parameters, means for receiving, based on the capability information, control signaling indicating one or more conditions under which the reflective surface is to maintain phase continuity, and means for relaying wireless signaling between at least a first wireless device and a second wireless device according to a phase continuity condition based on the one or more conditions.

A non-transitory computer-readable medium storing code for wireless communications at a reflective surface is described. The code may include instructions executable by a processor to transmit capability information indicating a capability to maintain phase continuity across a set of multiple transmissions according to a first set of transmission parameters, receive, based on the capability information, control signaling indicating one or more conditions under which the reflective surface is to maintain phase continuity, and relay wireless signaling between at least a first wireless device and a second wireless device according to a phase continuity condition based on the one or more conditions.

Some examples of the method, apparatuses, and non-transitory computer-readable medium described herein may further include operations, features, means, or instructions for transmitting, in the capability information, an indication of a first threshold time duration in which the reflective surface may be capable of switching from a second set of transmission parameters to the first set of transmission parameters and receiving, in the control signaling, an indication of a second threshold time duration that may be greater than or equal to the first threshold time duration, where the one or more conditions indicate that phase continuity may be maintained according to the phase continuity condition if the second threshold time duration may be satisfied by a timing offset between two transmissions associated with different sets of transmission parameters.

In some examples of the method, apparatuses, and non-transitory computer-readable medium described herein, relaying the wireless signaling may include operations, features, means, or instructions for relaying a first transmission according to the first set of transmission parameters, relaying a second transmission according to the second set of transmission parameters, and relaying a third transmission according to the first set of transmission parameters, where phase continuity may be maintained across the first transmission and the third transmission according to the phase continuity condition based on a timing offset between the second transmission and the third transmission satisfying the second threshold time duration.

In some examples of the method, apparatuses, and non-transitory computer-readable medium described herein, relaying the wireless signaling may include operations, features, means, or instructions for relaying a first transmission according to the first set of transmission parameters, relaying a second transmission according to the second set of transmission parameters, and relaying a third transmission according to the second set of transmission parameters or a third set of transmission parameters, where phase continuity may be not maintained across the first transmission and the third transmission according to the phase continuity condition based on a timing offset between the first transmission and the third transmission failing to satisfy the second threshold time duration.

Some examples of the method, apparatuses, and non-transitory computer-readable medium described herein may further include operations, features, means, or instructions for transmitting, in the capability information, an indication of a first threshold time duration during which the reflective surface may be capable of maintaining the first set of transmission parameters and receiving, in the control signaling, an indication of a second threshold time duration that may be less than or equal to the first threshold time duration, where the one or more conditions indicate that phase continuity may be maintained for one or more transmissions occurring within the second threshold time duration according to the phase continuity condition.

Some examples of the method, apparatuses, and non-transitory computer-readable medium described herein may further include operations, features, means, or instructions for relaying a set of multiple transmissions according to the first set of transmission parameters during the second threshold time duration, where phase continuity may be maintained across the set of multiple transmissions according to the phase continuity condition based on the set of multiple transmissions occurring during the second threshold time duration and upon expiration of the second threshold time duration, switching from the first set of transmission parameters to a second set of transmission parameters, where phase continuity may be not maintained according to the phase continuity condition after expiration of the second threshold time duration.

Some examples of the method, apparatuses, and non-transitory computer-readable medium described herein may further include operations, features, means, or instructions for changing a position of the reflective surface, transmitting an indication that the reflective surface may have changed position to one or more of a set of multiple wireless devices including at least a transmitting device and a receiving device, and refraining from maintaining phase continuity for subsequent wireless communications between the transmitting device and the receiving device based on changing the position.

Some examples of the method, apparatuses, and non-transitory computer-readable medium described herein may further include operations, features, means, or instructions for receiving, from a wireless device of a set of multiple wireless devices, an indication that the wireless device may have changed from a first position to a second position and refraining from maintaining phase continuity for subsequent wireless communications between the first wireless device and one or more additional wireless device based on the indication that the wireless device may have changed from the first position to the second position.

Some examples of the method, apparatuses, and non-transitory computer-readable medium described herein may further include operations, features, means, or instructions for receiving, from the wireless device, an indication that the wireless device may have returned to the first position and maintaining phase continuity for one or more additional wireless communications between the first wireless device and the one or more additional wireless devices based on the indication that the wireless device may have returned to the first position.

In some examples of the method, apparatuses, and non-transitory computer-readable medium described herein, the control signaling includes a radio resource control message, a media access control control element, a downlink control information, or any combination thereof, and the first wireless device includes a network entity and the second wireless device includes a user equipment (UE).

In some examples of the method, apparatuses, and non-transitory computer-readable medium described herein, the control signaling includes a sidelink control information message, a physical sidelink shared channel message, a media access control control element, a sidelink radio resource control message, or any combination thereof, and the first wireless device includes a first sidelink UE and the second wireless device includes a second sidelink UE.

In some examples of the method, apparatuses, and non-transitory computer-readable medium described herein, the first set of transmission parameters includes a first transmission beam, a first set of frequency resources, a first transmit power, a first set of antenna ports, a first precoding configuration, or any combination thereof.

In some examples of the method, apparatuses, and non-transitory computer-readable medium described herein, the capability information includes an indication of a class of reflective surface of a set of multiple classes of reflective surfaces, each class of reflective surfaces associated with a respective set of capabilities.

In some examples of the method, apparatuses, and non-transitory computer-readable medium described herein, the capability information may be associated with a frequency band, a frequency band combination, a carrier, or a carrier combination.

A method for wireless communications at a first wireless device is described. The method may include obtaining, from a reflective surface, capability information indicating a capability of the reflective surface to maintain phase continuity across a set of multiple transmissions according to a first set of transmission parameters, outputting, based on the capability information, control signaling indicating one or more conditions under which the reflective surface is to maintain phase continuity, and transmitting wireless signaling to at least a second wireless device via the reflective surface according to a phase continuity condition based on the one or more conditions.

An apparatus for wireless communications at a first wireless device is described. The apparatus may include a processor, memory in electronic communication with the processor, and instructions stored in the memory. The instructions may be executable by the processor to cause the apparatus to obtain, from a reflective surface, capability information indicating a capability of the reflective surface to maintain phase continuity across a set of multiple transmissions according to a first set of transmission parameters, output, based on the capability information, control signaling indicating one or more conditions under which the reflective surface is to maintain phase continuity, and transmit wireless signaling to at least a second wireless device via the reflective surface according to a phase continuity condition based on the one or more conditions.

Another apparatus for wireless communications at a first wireless device is described. The apparatus may include means for obtaining, from a reflective surface, capability information indicating a capability of the reflective surface to maintain phase continuity across a set of multiple transmissions according to a first set of transmission parameters, means for outputting, based on the capability information, control signaling indicating one or more conditions under which the reflective surface is to maintain phase continuity, and means for transmitting wireless signaling to at least a second wireless device via the reflective surface according to a phase continuity condition based on the one or more conditions.

A non-transitory computer-readable medium storing code for wireless communications at a first wireless device is described. The code may include instructions executable by a processor to obtain, from a reflective surface, capability information indicating a capability of the reflective surface to maintain phase continuity across a set of multiple transmissions according to a first set of transmission parameters, output, based on the capability information, control signaling indicating one or more conditions under which the reflective surface is to maintain phase continuity, and transmit wireless signaling to at least a second wireless device via the reflective surface according to a phase continuity condition based on the one or more conditions.

Some examples of the method, apparatuses, and non-transitory computer-readable medium described herein may further include operations, features, means, or instructions for obtaining, in the capability information, an indication of a first threshold time duration in which the reflective surface may be capable of switching from a second set of transmission parameters to the first set of transmission parameters and outputting, in the control signaling, an indication of a second threshold time duration that may be greater than or equal to the first threshold time duration, where the one or more conditions indicate that phase continuity may be maintained according to the phase continuity condition if the second threshold time duration may be satisfied by a timing offset between two transmissions associated with different sets of transmission parameters.

Some examples of the method, apparatuses, and non-transitory computer-readable medium described herein may further include operations, features, means, or instructions for outputting a first transmission associated with the first set of transmission parameters to the second wireless device, outputting a second transmission associated with a second set of transmission parameters to a third wireless device, and outputting a third transmission associated with the first set of transmission parameters to the second wireless device, where phase continuity may be maintained across the first transmission and the third transmission according to the phase continuity condition based on a timing offset between the second transmission and the third transmission satisfying the second threshold time duration.

Some examples of the method, apparatuses, and non-transitory computer-readable medium described herein may further include operations, features, means, or instructions for outputting a first transmission associated with the first set of transmission parameters to the second wireless device, outputting a second transmission associated with a second set of transmission parameters to a third wireless device, and outputting a third transmission associated with the second set of transmission parameters or a third set of transmission parameters to the second wireless device, where phase continuity may be not maintained across the first transmission and the third transmission according to the phase continuity condition based on a timing offset between the second transmission and the third transmission failing to satisfy the second threshold time duration.

Some examples of the method, apparatuses, and non-transitory computer-readable medium described herein may further include operations, features, means, or instructions for obtaining, in the capability information, an indication of a first threshold time duration during which the reflective surface may be capable of maintaining the first set of transmission parameters and outputting, in the control signaling, an indication of a second threshold time duration that may be less than or equal to the first threshold time duration, where the one or more conditions indicate that phase continuity may be maintained for one or more transmissions occurring within the second threshold time duration according to the phase continuity condition.

Some examples of the method, apparatuses, and non-transitory computer-readable medium described herein may further include operations, features, means, or instructions for outputting a set of multiple transmissions associated with the first set of transmission parameters during the second threshold time duration, where phase continuity may be maintained across the set of multiple transmissions according to the phase continuity condition based on the set of multiple transmissions occurring during the second threshold time duration and upon expiration of the second threshold time duration, switching from the first set of transmission parameters to a second set of transmission parameters, where phase continuity may be not maintained according to the phase continuity condition after expiration of the second threshold time duration.

Some examples of the method, apparatuses, and non-transitory computer-readable medium described herein may further include operations, features, means, or instructions for outputting control signaling indicating to the second wireless device indicating the one or more conditions under which the reflective surface may be to maintain phase continuity.

Some examples of the method, apparatuses, and non-transitory computer-readable medium described herein may further include operations, features, means, or instructions for obtaining an indication that the reflective surface may have changed position and refraining from maintaining phase continuity for subsequent wireless communications between the first wireless device and one or more additional wireless devices based on obtaining the indication that the reflective surface may have changed position.

Some examples of the method, apparatuses, and non-transitory computer-readable medium described herein may further include operations, features, means, or instructions for outputting, to the second wireless device, the obtained indication that the reflective surface may have changed position.

Some examples of the method, apparatuses, and non-transitory computer-readable medium described herein may further include operations, features, means, or instructions for outputting, to the reflective surface, an indication that at least one of the first wireless device or the second wireless device may have changed from a first position to a second position and refraining from maintaining phase continuity for subsequent wireless communications between the first wireless device and the second wireless device based on the indication that the at least one of the first wireless device or the second wireless device may have changed from the first position to the second position.

Some examples of the method, apparatuses, and non-transitory computer-readable medium described herein may further include operations, features, means, or instructions for outputting, to the reflective surface, an indication that at least one of the first wireless device or the second wireless device may have returned to the first position and maintaining phase continuity for one or more additional wireless communications between the first wireless device and the second wireless device based on the indication that the at least one of the first wireless device or the second wireless device may have returned to the first position.

In some examples of the method, apparatuses, and non-transitory computer-readable medium described herein, the control signaling includes a radio resource control message, a media access control control element, a downlink control information, or any combination thereof, and the first wireless device includes a network entity and the second wireless device includes a UE.

In some examples of the method, apparatuses, and non-transitory computer-readable medium described herein, the control signaling includes a sidelink control information message, a physical sidelink shared channel message, a media access control control element, a sidelink radio resource control message, or any combination thereof, and the first wireless device includes a first sidelink UE and the second wireless device includes a second sidelink UE.

In some examples of the method, apparatuses, and non-transitory computer-readable medium described herein, the capability information includes an indication of a class of reflective surface of a set of multiple classes of reflective surfaces, each class of reflective surfaces associated with a respective set of capabilities.

### BRIEF DESCRIPTION OF THE DRAWINGS

FIG. 1 illustrates an example of a wireless communications system that supports phase continuity associated with reconfigurable intelligent surfaces (RISs) in accordance with one or more aspects of the present disclosure.

FIG. 2 illustrates an example of a resource configuration that supports phase continuity associated with RISs in accordance with one or more aspects of the present disclosure.

FIG. 3 illustrates an example of a transmission timeline that supports phase continuity associated with RISs in accordance with one or more aspects of the present disclosure.

FIG. 4 illustrates an example of a timeline that supports phase continuity associated with RISs in accordance with one or more aspects of the present disclosure.

FIG. 5 illustrates an example of a transmission timeline that supports phase continuity associated with RISs in accordance with one or more aspects of the present disclosure.

FIG. 6 illustrates an example of a transmission timeline that supports phase continuity associated with RISs in accordance with one or more aspects of the present disclosure.

FIG. 7 illustrates an example of a process flow that supports phase continuity associated with RISs in accordance with one or more aspects of the present disclosure.

FIGS. 8 and 9 show block diagrams of devices that support phase continuity associated with RISs in accordance with one or more aspects of the present disclosure.

FIG. 10 shows a block diagram of a communications manager that supports phase continuity associated with RISs in accordance with one or more aspects of the present disclosure.

FIG. 11 shows a diagram of a system including a device that supports phase continuity associated with RISs in accordance with one or more aspects of the present disclosure.

FIGS. 12 and 13 show block diagrams of devices that support phase continuity associated with RISs in accordance with one or more aspects of the present disclosure.

FIG. 14 shows a block diagram of a communications manager that supports phase continuity associated with RISs in accordance with one or more aspects of the present disclosure.

FIG. 15 shows a diagram of a system including a UE that supports phase continuity associated with RISs in accordance with one or more aspects of the present disclosure.

FIG. 16 shows a diagram of a system including a network entity that supports phase continuity associated with RISs in accordance with one or more aspects of the present disclosure.

FIGS. 17 through 20 show flowcharts illustrating methods that support phase continuity associated with RISs in accordance with one or more aspects of the present disclosure.

### DETAILED DESCRIPTION

Some wireless communications systems may support multiple uplink transmissions (e.g., repetitions of a single message on a physical uplink shared channel (PUSCH) or physical uplink control channel (PUCCH), or different data or control messages transmitted on a PUSCH or PUCCH) while maintaining phase continuity across respective transmissions in different time slots. Maintaining the phase continuity may be referred to as bundling and may include using a same set of parameters (e.g., a same frequency resource, a same transmit power, a same spatial transmit relation, a same antenna port(s), a same precoding, etc.) for a respective set of uplink transmissions. Maintaining phase continuity may include transmitting a first transmission and a second transmission such that any phase discontinuities between the two transmissions stay below a threshold. For example, a difference between the phase of the first transmission and the phase of the second transmissions may satisfy a threshold phase difference (e.g., is about the same or within a threshold difference) at a boundary (e.g., a slot boundary) between the two transmissions. In cases of DMRS bundling, a receiving wireless device may jointly process DMRSs in one or more uplink transmissions, and may utilize channel information determined based on DMRSs in one time interval (e.g., slot) to determine channel information for another time interval.

A wireless device may perform DMRS bundling as part of uplink, downlink, or sidelink communications. Bundling one or more respective sets of transmissions may support joint processing of demodulation reference signals (DMRS) at a receiving device (e.g., a UE or a network entity). The receiving device may perform joint channel estimation across a set of transmissions received in multiple time slots (e.g., time intervals such as slots, mini-slots, sub-slots, symbols, frames, subframes, or the like) provided that the transmitting device maintains phase continuity across the set of transmissions. The receiving device may generate a joint channel estimate for the multiple time slots using the DMRS transmissions transmitted by the transmitting device, and may demodulate the multiple transmissions received using the joint channel estimate.

In some cases, a transmitting device (e.g., a network entity) may communicate with a receiving device (e.g., a UE) via a RIS. For example, the RIS may reflect a beam from the network entity to the UE in downlink communications and may similarly reflect a beam from the UE to the network entity in uplink communications. However, a RIS may change its beamforming matrix (e.g., may communicate according to one or more changed transmission parameters, such as transmissions using a separate beam), which may at times affect the UE capability to maintain phase continuity. For example, the RIS may change locations (e.g., a mobile RIS deployed as a moving node in a vehicle, or carried by a mobile user) or may change a transmit beam or a receive beam to communicate with another device (e.g., a second UE) between transmissions with a first UE. Accordingly, a quasi co-location (QCL) relation between DMRSs on different transmissions and reference signals may change. In such cases, the RIS may not be able to maintain phase continuity and consecutive or non-consecutive transmissions to the same receiving device may be non-coherent. Thus, some RISs (e.g., RISs deployed in cars, UAVs, or otherwise mobile RISs) may be turned off or have phase continuity disabled, and receiving devices in communication with the RIS may be unable to leverage channel knowledge across transmissions (e.g., may not be able to jointly process transmissions across multiple time intervals).

To maintain phase continuity at a receiving device and enable DMRS bundling, a RIS may signal to the receiving device, transmitting device, or both a capability to achieve a previous (e.g., an original) RIS configuration or beamformer based on one or more metrics. The transmitting device and receiving device may perform wireless communications based on one or more rules to indicating when a configuration or beamformer is to be changed, and when phase continuity is to be maintained. For example, a RIS may use a first beam to reflect a downlink communication from a network entity to a first UE. The RIS may use a second beam to reflect a second downlink communication from the network entity to a second UE. If the RIS is able to return to the original configuration used for communicating with the first UE (e.g., use the first beam), phase continuity with the first UE may be maintained and the first UE may be able to perform DMRS bundling and joint processing across multiple transmissions relayed by the RIS. Accordingly, the RIS may report an ability to achieve the same configuration (e.g., beam) or a similar configuration that is within an acceptable error limit from the previous configuration. The receiving device (e.g., UE) may determine whether phase continuity is maintained between communications (e.g., time intervals) and if DMRS bundling may be performed. In some examples, the network or a sidelink UE (e.g., a programmable logic controller (PLC)) may schedule communications to satisfy the reported capability of the RIS (e.g., the receiving device may assume that phase continuity is maintained for communications scheduled to satisfy the reported capabilities of the RIS, and may assume that phase continuity is broken for communications scheduled that do not satisfy the reported capabilities of the RIS). Techniques, methods, and apparatuses described herein may apply to uplink, downlink, and sidelink communications.

Aspects of the disclosure are initially described in the context of wireless communications systems. Aspects of the disclosure are further illustrated by and described with reference to a resource configuration, a communication pattern, timelines, and a process flow. Aspects of the disclosure are further illustrated by and described with reference to apparatus diagrams, system diagrams, and flowcharts that relate to phase continuity associated with RISs.

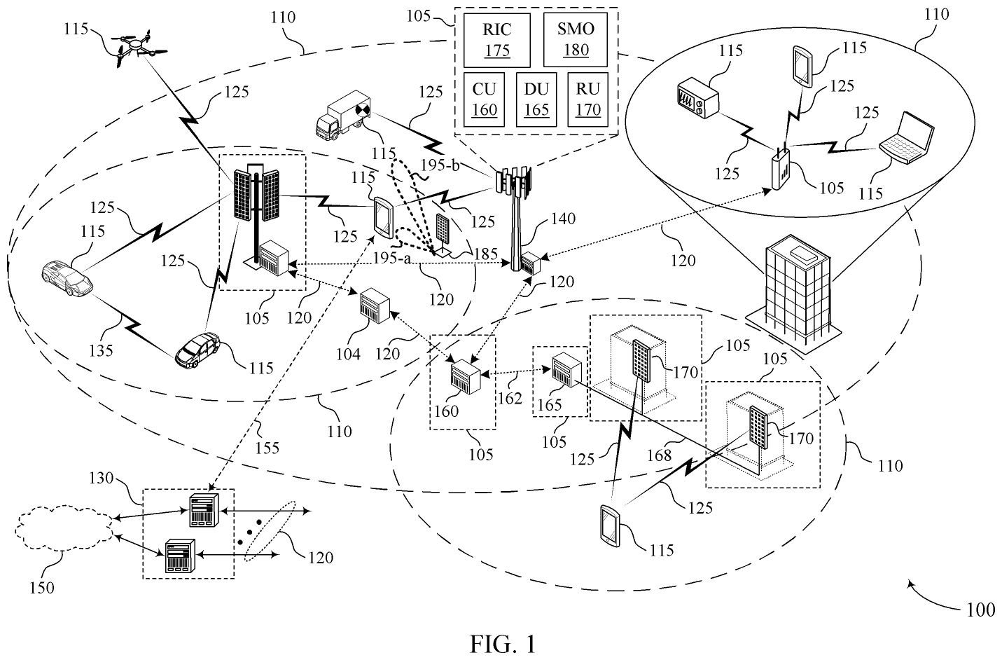

FIG. 1 illustrates an example of a wireless communications system 100 that supports phase continuity associated with RISs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, media access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support phase continuity associated with RISs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some wireless communications systems may support multiple uplink transmissions (e.g., repetitions of a single message on a physical uplink shared channel (PUSCH) or physical uplink control channel (PUCCH), or different data or control messages transmitted on a PUSCH or PUCCH) while maintaining phase continuity across respective transmissions in different time slots. Maintaining the phase continuity may be referred to as bundling and may include using a same set of parameters for a respective set of uplink transmissions (e.g., a same frequency resource, a same transmit power, a same spatial transmit relation, a same antenna port(s), a same precoding, etc.).

Bundling one or more respective sets of transmissions may support joint processing of DMRS at a receiving device (e.g., a network entity 105). The receiving device may perform joint channel estimation across a set of channels received in multiple time slots (e.g., time intervals such as slots, mini-slots, sub-slots, symbols, frames, subframes, or the like) provided that the transmitting device (e.g., UE 115) maintains phase continuity across the set of channels. The receiving device may generate a joint channel estimate for the multiple time slots using the DMRS transmissions transmitted by the transmitting device within the set of channels, and demodulate the multiple transmissions received within the set of channels using the joint channel estimate.

Some wireless communication systems may include active antenna units (AAUs) to increase throughput. Specifically, a AAU may be able to support high beamforming gain by using individual RF chains for each antenna port. However, AAUs may incur a significant increase in power consumption. To limit increased power consumption, a wireless communication system may employ a passive or near passive MIMO device as a substitute for AAU. For example, a reflective surface may be an example of a near passive MIMO device that a wireless communications system may employ to extend coverage with negligible power consumption. A reflective surface may include a RIS surface with passive RIS elements or one or more power amplifiers connected to the one or more RIS elements. A reflective surface may also include an amplify-and-forward relay (e.g., smart repeater, analog beamforming relay, etc.) that may perform amplifying, forwarding, and relaying. Additionally or alternatively, a radio frequency identification (RFID) tag that performs beamforming or backscattering may also be an example of a reflective surface. A reflective surface may include additional examples not listed herein. As described herein, an RIS device may refer to any such reflective surfaces.

A RIS 185 may be an example of a passive, or near passive (e.g., low-power), device that can reflect, refract, or otherwise passively steer signals (e.g., reflects impinging waves) in a desired direction. In some cases, the RIS 185 may not actively decode, encode, amplify, or otherwise process signals that are reflected by the RIS 185. For example, the RIS 185 may have a configurable (e.g., controllable) index (e.g., angle) of reflection or refraction (e.g., based on configurable properties, such as electromagnetic properties or electromechanical properties). A controller of the RIS 185 may configure (e.g., adjust) the RIS 185 to control the direction of reflection or refraction. In some cases, a network entity may control the direction of reflection. A RIS controller may adjust various gratings on the RIS 185 (e.g., a spacing, an orientation, or another property of the gratings) to steer incident waves in a desired direction.

In some cases, the RIS 185 may change location such as when deployed in a moving vehicle, which may cause a change in the beamforming matrix. Additionally, or alternatively, the RIS 185 may communicate with multiple other UEs 115 over time which may also cause a change in the beamforming matrix from time to time (e.g., QCL relation between DMRS on different transmissions and reference signals). For instance, the RIS 185 may communicate with a first receiving device using a first beam 195-a, and a second receiving device using a second beam 195-b, resulting in a change in beams, and ability to maintain phase continuity, over time. Such changes in phase continuity (e.g., due to changes in RIS position, or changes in RIS transmission or reception parameters) may prevent a receiving device (e.g., a UE 115) from performing bundling across transmissions.

To maintain phase continuity, the RIS 185 may maintain a RIS configuration or beamformer across transmission slots. The RIS 185 may signal to a wireless device (e.g., network entity 105 or UE 115), a capability to maintain a RIS configuration for a band, band combination, carrier, or carrier combination. Such a capability may indicate an ability of the RIS 185 to maintain a configuration within an acceptable error from the original configuration (e.g., configuration used in a first transmission). For example, the RIS 185 may switch configurations at predetermined times (e.g., such as during the slot of a last served UE 115). In some examples, the RIS 185 may indicate a threshold amount of time for switching from one set of transmission parameters to another set of transmission parameters (e.g., an amount of time used by the UE 115 to return to a previous configuration or a previously used beam). The UE 115 may be able to maintain phase continuity across non-consecutive transmissions if they are scheduled with sufficient time to allow the UE 115 to switch back to a previously used configuration or beam. Additionally, or alternatively, the RIS 185 may signal phase continuity capability based on classes of UEs 115 being served. In some examples, the RIS 185 may report a threshold value (e.g., an amount of time) during which the UE 115 is capable of maintain phase continuity, and may not maintain phase continuity if the time interval between transmissions exceeds the threshold value.

In some examples, the RIS 185 may not maintain phase continuity if the RIS 185, transmitting device, or receiving device changes position. The transmitting device (e.g., UE 115 or network entity 105) may receive the RIS 185 capability information and transmit control information to the RIS 185 which indicates conditions under which the RIS 185 may maintain phase continuity. Thus, a UE 115 or network entity 105 may have access to information regarding RIS 185 ability to maintain phase continuity and may perform bundling or refrain from bundling accordingly.

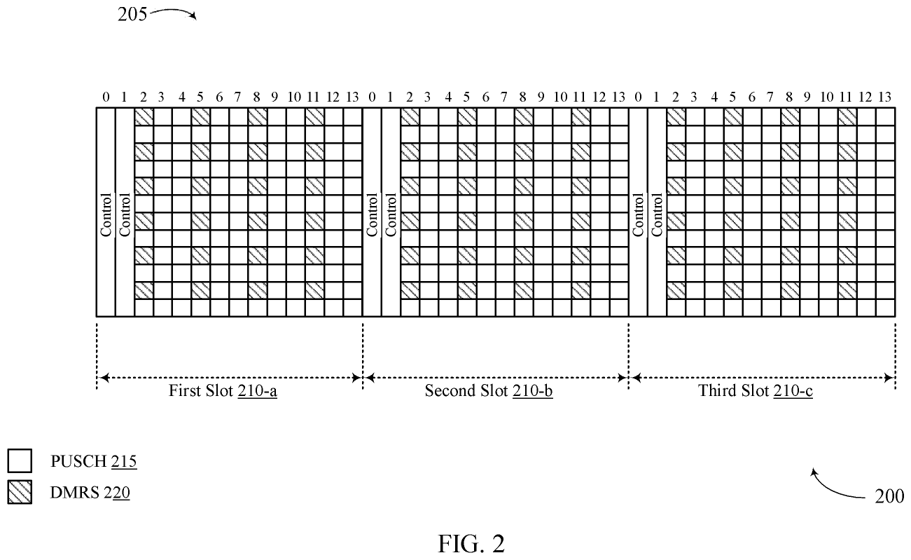

FIG. 2 illustrates an example of a resource configuration 200 that supports phase continuity associated with RISs in accordance with one or more aspects of the present disclosure. In some cases, phase continuity may also be referred to as phase coherence or phase coherency. In some examples, resource configuration 200 may implement, or be implemented by, aspects of wireless communications system 100. The resource configuration 200 illustrates a set of resources 205 across multiple slots 210 which may be used for transmission/reception of phase-coherent DMRSs. Although illustrated with reference to slots 210, techniques described with reference to FIG. 2 elsewhere herein, may also be performed for any TTI (e.g., slots, a mini-slots, sub-slots, symbols, frames, subframes, or the like). Additionally, although the resource configuration 200 includes PUSCH transmissions 215, techniques described herein may also be performed with reference to a PUCCH, physical downlink shared channel (PDSCH,) physical downlink control channel (PDCCH), physical sidelink control channel (PSCCH), or physical sidelink shared channel (PSSCH).

As noted herein, some wireless communications systems (e.g., wireless communications system 100) may enable wireless devices (e.g., UEs 115) to transmit bundled DMRSs 220 having phase continuity (e.g., phase-coherent DMRSs 220) to improve channel estimation. For example, a UE 115 may transmit a set of DMRSs 220 having phase continuity to a network entity 105 within a set of resources which are known by both the UE 115 and the network entity 105. In this example, because the DMRSs 220 having phase continuity are received by the network entity 105 within a set of known resources, the network entity 105 may be configured to aggregate the DMRSs 220 having phase continuity to determine a more accurate channel estimation of the channel between the UE 115 and the network entity 105. The network entity 105 may then be able to use the improved channel estimation to demodulate (e.g., decode) other transmissions (e.g., PUSCH transmissions 215) received from the UE 115 via the channel. In some aspects, the PUSCH transmissions 215 may also be transmitted with phase continuity across the respective slots 210.

Some wireless communications systems have enabled DMRSs 220 to be bundled only within a single TTI, but not across multiple TTIs. For example, in some wireless communications systems, a UE 115 may be configured to transmit a set of DMRSs 220 having phase continuity within the first slot 210-a, but may be unable to maintain phase continuity for DMRSs 220 transmitted in different slots 210. For instance, in some wireless communications systems, a UE 115 may be unable to maintain phase continuity across DMRSs 220 which are transmitted within the first slot 210-a and the second slot 210-b. In this regard, phase continuity may be maintained for DMRSs 220 within each respective slot 210, but may not be maintained for DMRSs 220 across multiple slots 210.

In some other wireless communications systems (e.g., wireless communications system 100), DMRSs 220 may be bundled across multiple slots and/or across multiple transmissions (e.g., PUCCH or PUSCH transmissions), such that phase continuity may be maintained across multiple slots 210 and/or across the multiple transmissions. For example, in the wireless communications system 100, a UE 115 may be configured to transmit a DMRSs 220 within the first slot 210-a, the second slot 210-b, and the third slot 210-c, where phase continuity is maintained across each of the slots 210-a, 210-b, and 210-c. In this example, a network entity 105 may be configured to jointly process (e.g., aggregate) the phase-coherent DMRSs 220 received across the slots 210-a, 210-b, and 210-c when performing channel estimation (e.g., cross-slot channel estimation), and may use a determined channel estimate to demodulate the PUSCH transmissions 215 (e.g., PUSCH transmissions 215 having phase continuity) received across the slots 210-a, 210-b, and 210-c.

In some examples, one or more parameters or characteristics may be maintained for phase-coherent DMRSs 220 which are bundled across one or more slots 210. Parameters which may be used to maintain phase continuity for DMRSs 220 associated with one or more PUSCH transmissions 215 may include, but are not limited to, phase, frequency allocations, transmission powers, spatial transmission relations, antenna ports used for transmission, precoding schemes, and the like. For example, as illustrated in FIG. 2, in cases where DMRSs 220 are bundled across the first slot 210-a, the second slot 210-b, and the third slot 210-c, the frequency allocation and transmit for the DMRSs 220 within each respective slot 210 may remain the same. Conversely, phase-continuity may not be maintained across slots 210 and/or other transmissions (e.g., phase discontinuity) in cases where DMRSs 220 in respective slots 210 exhibit one or more different parameters (e.g., different phases, different frequency resource allocations within or between PUSCH slots, non-contiguous time resource allocation of PUSCH slots, different transmit powers, different antenna ports, different transmission powers, different timing advances).

In some aspects, the ability to bundle DMRSs 220 across multiple slots 210 (e.g., maintain phase continuity for DMRSs 220 across multiple slots 210) and/or across multiple transmissions (e.g., multiple PUSCH transmissions 215) may enable improved channel estimation at a receiving device (e.g., network entity 105). In particular, by enabling for larger quantities of DMRSs 220 to be aggregated across multiple slots 210, a network entity 105 may be able to determine a more comprehensive channel estimation (e.g., cross-slot channel estimation), which may improve an ability of the network entity 105 to demodulate received PUSCH transmissions 215.

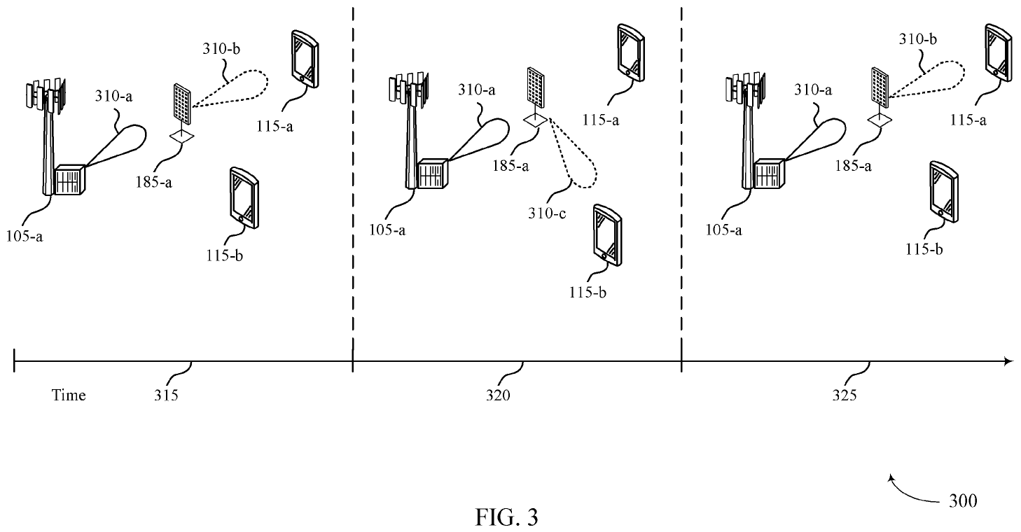

In some examples, a transmitting device and a receiving device may communicate via a RIS 185, as described in greater detail with reference to FIG. 3. the transmitting and receiving devices may be able to maintain phase continuity between the transmitting device, the receiving device, and the RIS 185, if the following conditions are satisfied: if communications occur across a same frequency resource allocation, if transmissions are sent according to a same transmit power, if same beams or transmission configurations are used (e.g., same spatial transmission relational, antenna ports, and precoding, among other examples), if an RIS position is the same, and if an RIS configuration or beamformer are the same across transmission. Different RISs 185 may have different capabilities.

In some examples, a UE 115 may transmit bundling capability information to a network entity. The network entity may then schedule multiple uplink channels according to the bundling capability information (e.g., such that the UE is able to maintain phase continuity across the scheduled multiple uplink channels without exceeding its capability to permit the network entity to perform joint channel estimation). For example, RISs 185 may report capability (e.g., to the network entity 105) indicating rules or conditions under which they are able to maintain phase continuity. Subsequent communications may be scheduled according to the RIS 185 capabilities, and receiving devices may perform joint processing and reception across transmissions and channels if the conditions are satisfied such that the RIS 185 is able to maintain phase continuity.

FIG. 3 illustrates an example of a transmission timeline 300 that supports phase continuity associated with RISs in accordance with one or more aspects of the present disclosure. In some examples, transmission timeline 300 may implement, or be implemented by, aspects of wireless communications system 100 and resource configuration 200. Network entity 105-a, UE 115-a, and UE 115-b may be examples of network entity 105 and UE 115 as described in FIG. 1. In the example shown in FIG. 3, network entity 105-a may function as a transmitting device and UE 115-a and UE 115-b may function as a receiving devices. As such, network entity 105-a may communicate with UE 115-a and UE 115-b via the RIS 185-a. The RIS 185-a may include a RIS controller. The following techniques and methods described in reference to FIG. 3 may similarly be applied to uplink transmissions and sidelink transmissions.

Network entity 105-a may increase throughput by communicating with both UE 115-a and UE 115-b via the RIS 185-a. For example, the RIS 185-a may reflect transmissions from network entity 105-a to each of the respective UEs 115. For example, a blockage may prevent the network entity 105-a from communicating directly with one or both of the UE 115-a and the UE 115-b. However, the RIS 185-a may relay (e.g., reflect) transmission from the network entity 105-a to the UE 115-a or the UE 115-b, resulting in successful communication that might otherwise by impossible.

In some cases, network entity 105-a may transmit multiple downlink transmissions to UE 115-a over multiple time slots, and UE 115-a may perform joint channel estimation across a set of downlink channels received in multiple time slots (e.g., time intervals such as slots, mini-slots, sub-slots, symbols, frames, subframes, or the like). UE 115-a may generate a joint channel estimate for the multiple time slots using the DMRS transmissions transmitted by network entity 105-a within the set of downlink channels, and demodulate the multiple downlink transmissions received within the set of downlink channels using the joint channel estimate provided that phase continuity may be maintained. Specifically, network entity 105-a may maintain phase continuity if network entity 105-a uses the same frequency resource allocation, transmit power, spatial transmission relation, antenna ports, and precoding across multiple transmissions. Additionally, the RIS 185-a may maintain phase continuity when the RIS 185-a uses the same configuration and beamformer across transmissions, and remains stationary. If the RIS 185-a changes position or changes the beam or phase angle between transmissions with UE 115-a, UE 115-a may be unable to perform bundling and joint processing. However, if the UE 115-a is unable to determine the capability of the RIS 185-a to maintain phase continuity, joint processing and DMRS bundling may fail, or channel estimation may be based on faulty continuity assumptions, resulting in poor channel estimation.

As described herein, uplink and downlink phase continuity may be relevant to channel estimation quality. That is, DMRS bundling and joint channel estimation may be successful in cases where phase continuity is maintained, as described in greater detail with reference to FIG. 2. Phase continuity may be maintained by a RIS 185-a if the RIS is stationary, and can maintain one or more transmission parameters. However, RIS 185-a may be mobile, or may communicate using various different transmission parameters. For example, the RIS 185-a may be a moving node in a vehicle, or may communicate with multiple UEs 115. Given that a RIS may be deployed in a network, and may change beamforming matrix from time to time, phase continuity may change (e.g., as a result of a change in beamforming, a change in a QCL relation between DMRSs on different transmissions and reference signals, etc.). If the RIS cannot maintain transmission parameters (e.g., a beamforming matrix) across transmissions, then downlink uplink, or sidelink transmission may be non-coherent. In such examples, RISs 185-a (e.g., deployed in cars, or UAVBs, or mobile RISs in general) may be turned off, or continuity may be disabled in their presence.

For example, the network entity 105-a may communicate with the UE 115-a and the UE 115-b via the beam 310-a. The network entity 105-a may maintain phase continuity across multiple time intervals (e.g., during slot 315, slot 320, and slot 325) by using the same transmission parameters (e.g., the same beam 310-a). The RIS 185-a may relay information (e.g., reflect the beam 310-a) to the UE 115-a via the beam 310-b during slot 315. However, communications from the network entity 105-a during slot 320 may be directed toward the UE 115-b. Thus, the RIS 185-a may relay the communications from the network entity 105-a (e.g., may reflect the beam 310-a) to the UE 115-b via the beam 310-c during slot 320. During slot 325, the network entity 105-a may communicate with the UE 115-a again, via the same beam 310-a. The RIS 185-a may relay the signaling to the UE 115-a via the beam 310-b.

If the RIS 185-a is able to use a same RIS configuration, or a configuration (e.g., set of transmission parameters) that is within an error from an original configuration (e.g., the configuration used in a previous transmission), then the RIS may maintain phase continuity. For example, if the RIS 185-a is able to use the same transmission parameters (e.g., the same beam 310-b, from the same position, among other examples) during slot 325 as the RIS 185-a used during slot 315, then the RIS 185-a may be able to maintain phase continuity across the slot 315 and the slot 325. However, if the RIS 185-a is unable to maintain phase continuity across the slot 315 and the slot 325, phase continuity may be broken. If the UE 115-a attempts to perform joint processing of received signaling from slot 315 and slot 325, but the RIS 185-a was unable to maintain phase continuity, then the channel estimation may be poor, resulting in failed communications, increased system latency, and decreased user experience.

As described herein, the RIS 35 may indicate a capability to achieve the same RIS configuration and beamformer within an error threshold (e.g., a delta value) based on one or more metrics (e.g., a minimized mean square error (MMSE of a first beam or beam angle Φ₁ at a first time and the first beam angle Φ₁ at a second time). For example, the RIS 185-a may indicate its capability to utilize beam 310-b during slot 315 and beam 310-b (e.g., or a beam 310 that is within a threshold difference from beam 310-b) during slot 325. Such capability may be indicated for each band, band combination, carrier, carrier combination, or the like. The RIS 185-a may indicate the capability information during an initial access procedure, or during a capability exchange via layer1, layer 2, or layer 3 signaling (e.g., via RRC signaling, media access control control element (MAC-CE) signaling, downlink control information (DCI) signaling, or sidelink control information (SCI) signaling, among other examples).

In some examples, the RIS 185-a may belong to a RIS class having defined capability parameters. For example, different RIS classes may be associated with an error threshold (e.g., delta value) for achieving a same configuration (e.g., returning to an original configuration after changing configurations). In some cases, UE 115-a may indicate a RIS class that is associated with a particular error threshold for maintaining phase continuity. In some cases, the UE 115-a may indicate, in the capability information, an acceptable error threshold value. If the RIS 185-a belongs to a RIS class with an acceptable error threshold, UE 115-a may determine that the RIS 185-a may be capable of maintaining phase continuity under some conditions.

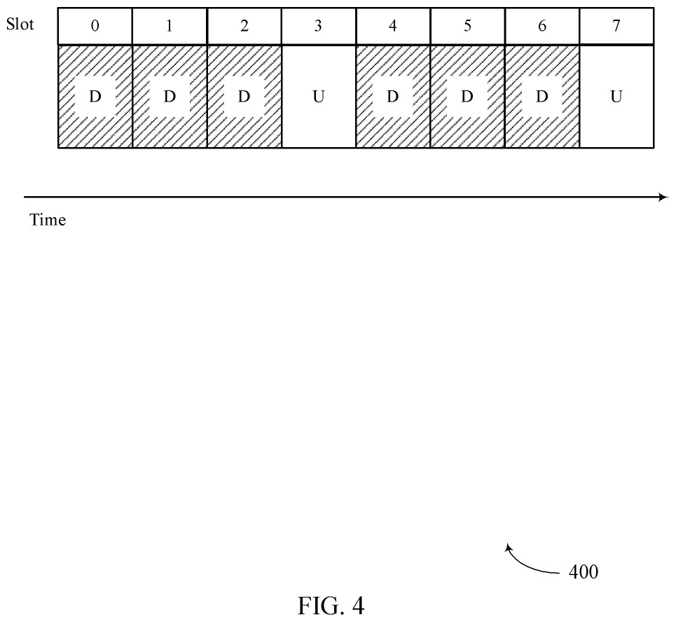

FIG. 4 illustrates an example of a timeline 400 that supports phase continuity associated with RISs in accordance with one or more aspects of the present disclosure. In some examples, timeline 400 may implement, or be implemented by, one or more wireless devices, such as a UE, a network entity, and a RIS, which may be examples of corresponding devices described with reference to FIGS. 1-3. Although FIG. 4 is described in the context of downlink, the same techniques and methods may also be applied to uplink and sidelink communications.

A RIS may relay signaling over multiple time slots, as described with reference to FIG. 3. For example, the RIS may be configured with a TDM configuration, where each time slot (e.g., each time interval, such as a slot, sub-slot, mini-slot, symbol, or the like) is allocated as an uplink time slot (e.g., U) or a downlink time slot (e.g., D). On a downlink time slot the RIS may relay signaling from the network entity to a UE. The network entity may transmit to different UEs over multiple time slots. For example, the network entity may communicate with a first UE via the RIS during time slot 0 and the network entity may communicate with a second UE via the RIS during time slot 1. As such, the RIS may change configuration on each usage to support the network entity transmitting to a different UE or set of UEs.

For example, the network entity, the RIS, and the UE may communicate according to a TDM pattern, such as DDDU, as illustrated with reference to timeline 400. In some examples, the RIS may assist the network entity by relaying downlink signaling according to a pattern of 1110, where 1 indicates that the RIS is relaying downlink signaling (e.g., during slots 0, 1, and 2, as well as 4, 5, and 6), and 0 indicates that the UE is not relaying downlink signaling (e.g., is inactive or is available to relay uplink signaling, during slots 3 and 7). In some examples, the RIS may change configurations at each usage to relay downlink communications to different UEs, or to a set of UEs or wireless devices), and may relay signaling for downlink signaling (e.g., but not uplink signaling). In such examples, the RIS may change its configuration from slot 0 to slot 1 to relay downlink signaling to different UEs (e.g., slot 315 and slot 320 as illustrated with reference to FIG. 3).

The RIS, the one or more UEs, and the network entity, may communicate according to one or more rules indicating when to switch from, or back to, specific configurations (e.g., sets of transmission parameters, beamformers, etc.). Such rules may apply to a last served UE, or a last or most recent change of phase configuration (e.g., such information may be stored or otherwise available for a network entity, or sidelink UE such as a PLC). The network entity and the UE may therefore determine when phase continuity is maintained (e.g., when the network entity is able to maintain phase continuity) based on the rules, or the defined pattern. For instance, a receiving UE (e.g., the UE 115-a described with reference to FIG. 3) may determine, according to the rules, that the RIS will use a same configuration (e.g., a same beamformer, same set of transmission parameters, etc.) to communicate with the UE during slot 0 and during slot 2, and may therefore determine that phase continuity is maintained by the RIS across slot 0 and slot 2.

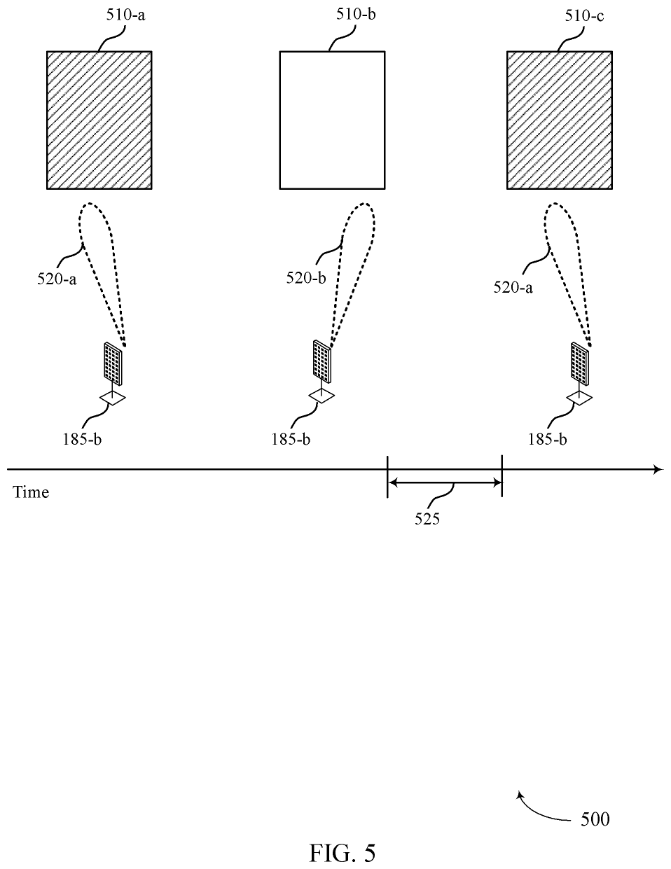

In some examples, as described in greater detail with reference to FIG. 5, the RIS capability to switch back to a configuration or set of transmission parameters may be limited by time. Such time constraints may be indicated in the capability information (e.g., an indication of the timing, or an indication of a RIS class associated with such timing constraints).

FIG. 5 illustrates an example of a transmission timeline 500 that supports phase continuity associated with RISs in accordance with one or more aspects of the present disclosure. In some examples, transmission timeline 500 may implement, or be implemented by, one or more wireless devices, such as a UE, a network entity, and a RIS 185-b, which may be examples of corresponding devices described with reference to FIGS. 1-4.

In some cases, the RIS 185-b may be able to switch back to a previous configuration (e.g., beamformer or set of transmission parameters) and therefore maintain phase continuity within a threshold amount of time (e.g., the RIS 185-b may use a threshold amount of time X, which may be defined as a quantity of time units, such as symbols, to switch from a second configuration back to a previously used configuration). If the RIS 185-b does not have sufficient time to switch back to a previous configuration (e.g., if a next transmission is scheduled less than the threshold amount of time after a previous transmission using a different configuration), then the RIS may be unable to maintain phase continuity (e.g., transmissions bundled by the network entity my not be treated as part of a DMRS bundle by the receiving UE).

For example, the RIS 185-b may relay downlink signaling 510-a via beam 520-a (e.g., to a first UE, such as the UE 115-a, using beam angle Φ₁). During another time interval, the RIS 185-b may relay downlink signaling 510-b via beam 520-b (e.g., to a second UE, such as the UE 115-b, using beam angle Φ₂). During another time interval, the RIS 185-b may be scheduled to relay downlink signaling 510-c via the same beam 520-a (e.g., or via a set of transmission parameters that are within a threshold error from transmission parameters used to relay the downlink signaling 510-a). The downlink signaling 510-c may occur after a time offset 525 from the downlink signaling 510-b. If the offset 525 satisfies the threshold (e.g., is equal than or greater than the threshold amount of time used by the RIS 185-b to change back to the previous configuration), then the RIS 185-b may be able to maintain phase continuity across the downlink signaling 510-a and the downlink signaling 510-c, and the receiving UE may be able to perform joint processing on the downlink signaling 510-a and the downlink signaling 510-c. However, if the offset 525 does not satisfy the threshold (e.g., is less than the threshold amount of time), then a bundle may be assumed to be canceled (e.g., phase continuity across the downlink transmission 510-a and the downlink transmission 510-c is broken), or the RIS 185-b may not be able to attain the same configuration or beamformer as used for downlink signaling 510-a.

In some examples, the RIS 185-b may be serving two or more UEs with a same configuration (e.g., a same beam or other transmission parameters) or configurations that are within a delta error. In such examples, phase continuity is assumed to hold. Otherwise (e.g., if the UE is serving different UEs using different configurations), it may be assumed that there is no phase continuity (e.g., that phase continuity is not maintained by the RIS 185-b while communicating with multiple devices).

In some examples, the RIS 185-b may report (e.g., in the capability information) the threshold amount of time in which the RIS 185-b is capable of switching back to a previously used configuration (e.g., beamformer or other transmission parameters). Such capability signaling may be transmitted via layer 1, layer 2, or layer 3 signaling (e.g., DCI signaling, MAC-CE signaling, RRC signaling for a Uu interface, or SCI signaling, PSSCH signaling, MAC-CE signaling, or RRC signaling for a sidelink interface).

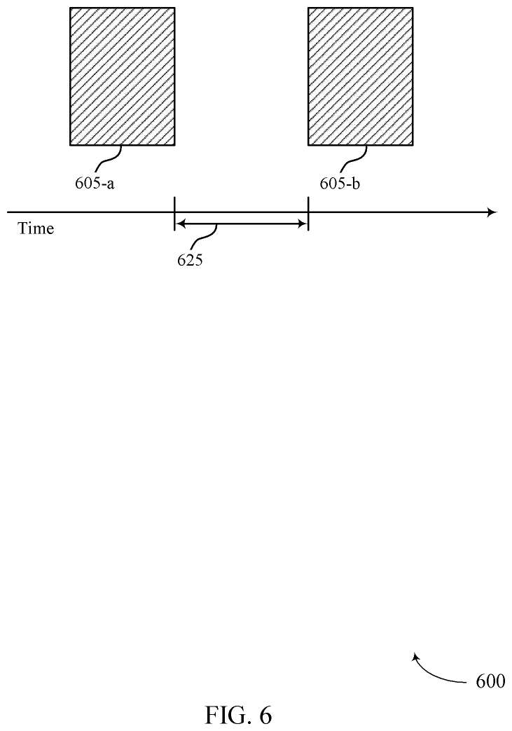

In some examples, as described in greater detail with reference to FIG. 6, the RIS 185-b may serve a set of UEs for a period of time, and grants may be separated by a threshold amount of time based on capability of the RIS 185-b to maintain phase continuity over time.

FIG. 6 illustrates an example of a transmission timeline 600 that supports phase continuity associated with RISs in accordance with one or more aspects of the present disclosure. In some examples, timeline 600 may implement, or be implemented by, one or more wireless devices, such as a UE 115, a network entity 105, and a RIS 185, which may be examples of corresponding devices described with reference to FIGS. 1-5.

In some cases, a RIS may serve the same UE 115 or set of UEs 115 over a time period. Granted resources (e.g., or grants of resources) may be separated by at least a threshold amount of time X. The threshold amount of time may be a function of an ability of the RIS (e.g., the RIS controller) to maintain one or more transmission parameters (e.g., a beam angle Φ₁) to be the same. For example, the RIS may include one or more RIS elements (e.g., antenna elements) that are associated with active radio frequency components, power amplifiers, etc., and the RIS may be able to maintain a single beam for up to a threshold amount of time. If the network grants resources for downlink transmission 605-a and downlink transmission 605-b at an offset 625 from each other, and if the offset 625 does not satisfy the threshold (e.g., if the offset 625 is greater than the threshold amount of time, where there were no scheduled reflections for the RIS controller) then the RIS may not keep the RIS surface on, and may break phase continuity. However, for any transmissions scheduled within the threshold amount of time (e.g., for a group of one or more UEs such that the RIS can use the same beam to communicate over multiple transmissions 605), the RIS may be assumed to maintain phase continuity across any transmissions scheduled within the threshold amount of time.

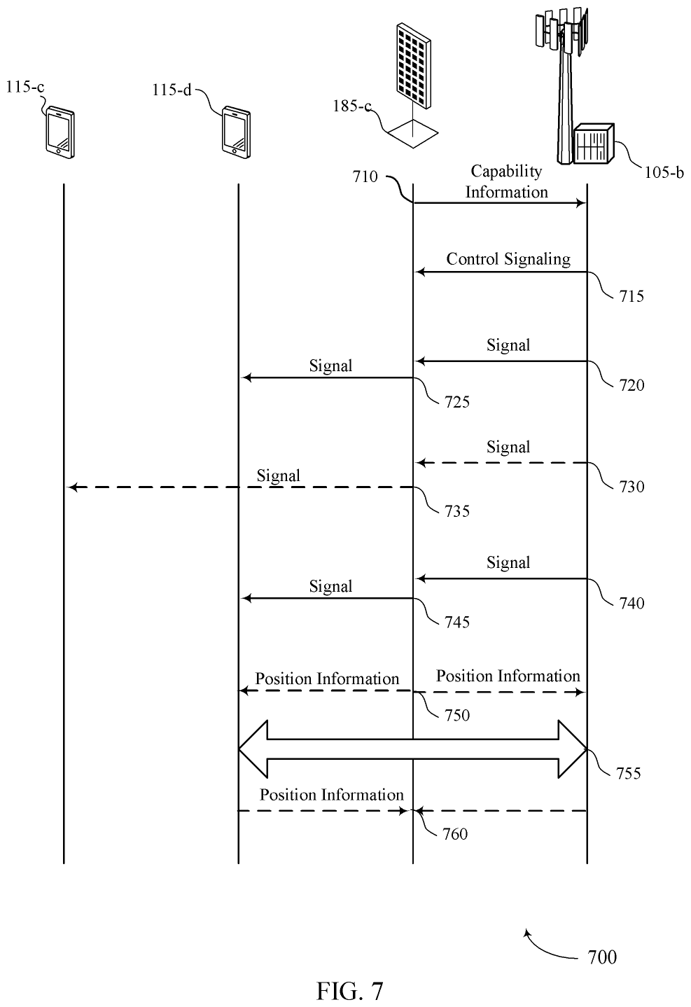

FIG. 7 illustrates an example of a process flow 700 that supports phase continuity associated with RISs in accordance with one or more aspects of the present disclosure. In some examples, process flow 700 may implement aspects of wireless communication system 100. The process flow 700 may illustrate examples of a UE 115-c, a UE 115-d, a network entity 105-b, and a RIS 185-c, as described with reference to FIGS. 1-6. Alternative examples of the following may be implemented, in which some processes are performed in a different order than described or are not performed. In some cases, processes may include additional features not mentioned below, or further processes may be added. Although process flow 700 illustrates phase continuity with RISs in the context of downlink transmissions, the methods described herein may also be applied to uplink transmissions.

At 710, the RIS 185-c may transmit capability information indicating a capability to maintain phase continuity across a set of transmissions according to a first set of transmission parameters. A layer 1, layer 2, or layer 3 message may be an example of the capability information message transmitted at 710. In some cases, the capability information may include an indication of a first threshold time duration in which the RIS 185-c may be capable of switching from a second set of transmission parameters to the first set of transmission parameters. For example, the RIS 185-c may indicate a quantity of symbols or time units for switching between consecutive transmissions in order to switch back to the first set of transmission parameters.

At 715, the RIS 185-c may receive, based at least in part on the capability information, control signaling indicating one or more conditions under which the RIS 185-c may maintain phase continuity. An RRC message, MAC-CE, and DCI may each be an example of the control signaling received at 715. The control information may include an indication of a second threshold time duration that may be greater or equal to the first threshold time duration. The RIS 185-c may maintain phase continuity when the second threshold is satisfied (e.g., when transmissions are scheduled to satisfy the second threshold time duration). For example, network entity may configure the second threshold such that when the time offset between consecutive transmissions is satisfied, the RIS 185-c may maintain phase continuity.

At 720, network entity 105 may output wireless signaling to UE 115-d via the RIS 185-c according to a phase continuity condition based at least in part on the one or more conditions indicated in the capability information. The phase continuity condition may include one or more conditions under which the RIS 185-c does, or does not, maintain phase continuity. At 725, the RIS 185-c may relay the signal between network entity 105-b and UE 115-d according to a phase continuity condition based at least in part on the one or more conditions. The RIS 185-c may relay the signal according to a first set of transmission parameters and UE 115-d may bundle the received transmission with a subsequent transmission received at 745, if the RIS 185-c maintains phase continuity according to the phase continuity condition.

At 730, network entity 105-b may output a second signal associated with a second set of transmission parameters to UE 115-c. At 735, the RIS 185-c may relay the second signal from network entity 105-b to UE 115-c according to the second set of transmission parameters.

At 740, network entity 105-b may output a third signal associated with the first set of transmission parameters to UE 115-d. At 745, the RIS 185-c may relay the third signal from network entity 105-b to UE 115-c according to the first set of transmission parameters. In some cases, the RIS 185-c may maintain phase continuity across the transmission at 725 and the transmission at 745. The RIS 185-c may maintain phase continuity based on a timing offset between the transmission at 735 and the transmission at 745. For example, the RIS 185-c may maintain phase continuity when the timing offset is greater than the second threshold (e.g., configured time for the RIS 185-c to switch parameter sets). Additionally, or alternatively, the RIS 185-c may not maintain phase continuity, and UE 115-d may cancel bundling, when the timing offset may be less than the second threshold.

In some cases, the RIS 185-c may relay multiple (e.g., consecutive transmissions to the same receiving device (e.g., UE 115-d), as described in FIG. 6. For example, network entity 105-b may not transmit to UE 115-c at 730 and the RIS 185-c may not relay a transmission to UE 115-c at 735. As such, the RIS 185-c may maintain phase continuity if the RIS 185-c relays the transmission at 725 and the transmission at 745 within a threshold time. Specifically, the RIS 185-c may transmit, in the capability information at 710, an indication of a first threshold time duration during which the RIS 185-c is capable of maintaining a first set of transmission parameters (e.g., transmission parameters, such as a beam, transmit power, etc., used at 725). The RIS 185-c may receive, in the control signaling at 715, an indication of a second threshold time duration that is less than or equal to the first threshold time duration. For example, the network entity 105-b may configure the RIS 185-c to maintain phase continuity for the second threshold time duration, and the second threshold time durations may be indicated to be the same as or less than the indicated capability reported by the UE 115-d. In some cases, one or more conditions in the control signaling may indicate that the RIS 185-c is to maintain phase continuity for the transmissions at 725 and 745 within the second threshold time duration according to the phase continuity condition.

In some cases, the RIS 185-c may not maintain phase continuity after the expiration of the second threshold time duration. For example, at 725 the RIS 185-c may relay a set of transmissions according to the first set of transmission parameters during the second threshold time duration. The RIS 185-c may maintain phase continuity across the set of transmissions at 725 according to the phase continuity condition based on the set of transmissions at 725 occurring during the second threshold time duration. When the second threshold time duration expires, the RIS 185-c may switch from the first set of transmission parameters to a second set of transmission parameters. As such, the RIS 185-c may not maintain phase continuity according to the phase continuity condition after the expiration of the second threshold time duration.

Thus, the RIS 185-c may not maintain phase continuity between the transmission at 725 and the transmission at 745 when the transmission 745 occurs after the expiration of the second threshold time duration.

In some examples, the RIS 185-c may change position. As such, at 750 the RIS 185-c may transmit an indication that the RIS 185-c changed position to network entity 105-b, UE 115-d, or both. Based on the indication that the RIS 185-c has changed position, the UE 115-d and the network entity 105-b may determine that phase continuity is broken. In some examples, the RIS 185-c may transmit the position information at 750 to network entity 105-b, and network entity 105-b may notify UE 115-d at 755 that the RIS 185-c may not maintain phase continuity. Additionally, or alternatively, the RIS 185-c may transmit the position information at 750 to UE 115-d and UE 115-d may notify network entity 105-b that the RIS 185-c may not maintain phase continuity. Accordingly, the RIS 185-c may not maintain phase continuity for subsequent wireless communications between network entity 105-b and UE 115-d based on changing position at 750.

In some examples, network entity 105-b, UE 115-d, or both, may change positions. At 760, the RIS 185-c may receive, from network entity 105-b or UE 115-d, an indication that the network entity 105-b, UE 115-d, or both changed from a first position to a second position. As such, the RIS 185-c may determine that phase continuity is broken for subsequent wireless communications between network entity 105-b and UE 115-d based on the indication of the change from the first position to the second position. In some examples, at 755, network entity 105-b and UE 115-d may communicate the change in position to each other. At 760, the RIS 185-c may receive, from network entity 105-b, UE 115-d, or both, an indication that network entity 105-b, UE 115-d, or both may have returned to the first position. As such, the RIS 185-c may maintain phase continuity between network entity 105-b and UE 115-d based on the indication at αthat network entity 105-b, UE 115-d, or both returned to the first position. Similarly, in some examples, if the RIS 185-c returns to its original position or is otherwise able to return to its initial configuration or set of transmission parameters, the RIS 185-c may transmit an indication of its updated position to the network entity 105-b, the UE 115-d, or both (e.g., if the RIS 185-c indicates a change in position, or a return to a previous position, to one of the network entity 105-b and the UE 115-d, then the network entity 105-b and the UE 115-d may exchange signaling to convey that information to each other).

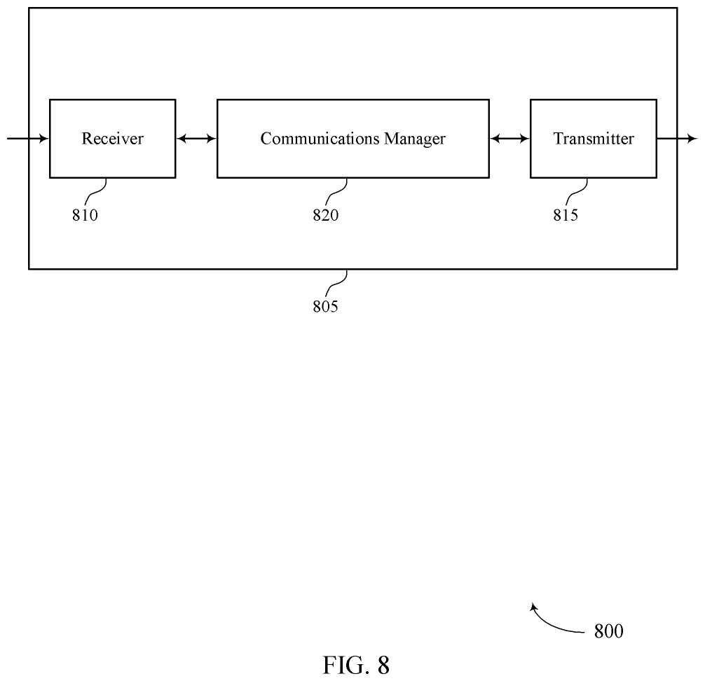

FIG. 8 shows a block diagram 800 of a device 805 that supports phase continuity associated with RISs in accordance with one or more aspects of the present disclosure. The device 805 may be an example of aspects of a RIS as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas.

Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of phase continuity associated with RISs as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at an reflective surface in accordance with examples as disclosed herein. For example, the communications manager 820 may be configured as or otherwise support a means for transmitting capability information indicating a capability to maintain phase continuity across a set of multiple transmissions according to a first set of transmission parameters. The communications manager 820 may be configured as or otherwise support a means for receiving, based on the capability information, control signaling indicating one or more conditions under which the reflective surface is to maintain phase continuity. The communications manager 820 may be configured as or otherwise support a means for relaying wireless signaling between at least a first wireless device and a second wireless device according to a phase continuity condition based on the one or more conditions.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a reflective surface to maintain phase continuity across transmissions, which may reduce power consumption and more efficiently utilize communication resources.

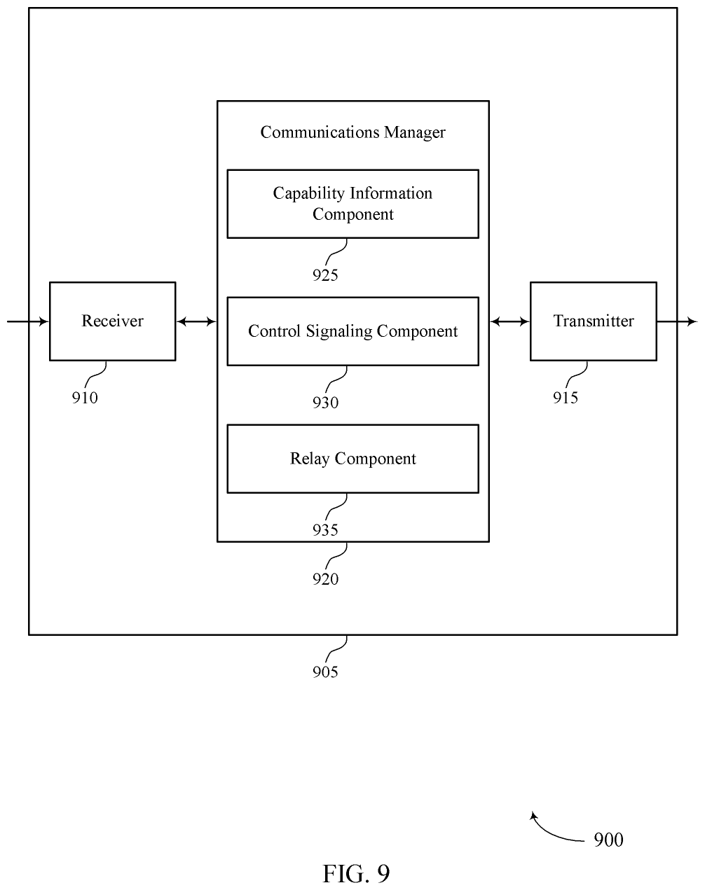

FIG. 9 shows a block diagram 900 of a device 905 that supports phase continuity associated with RISs in accordance with one or more aspects of the present disclosure. The device 905 may be an example of aspects of a device 805 or a reflective surface as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of phase continuity associated with RISs as described herein. For example, the communications manager 920 may include a capability information component 925, a control signaling component 930, a relay component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a reflective surface in accordance with examples as disclosed herein. The capability information component 925 may be configured as or otherwise support a means for transmitting capability information indicating a capability to maintain phase continuity across a set of multiple transmissions according to a first set of transmission parameters. The control signaling component 930 may be configured as or otherwise support a means for receiving, based on the capability information, control signaling indicating one or more conditions under which the reflective surface is to maintain phase continuity. The relay component 935 may be configured as or otherwise support a means for relaying wireless signaling between at least a first wireless device and a second wireless device according to a phase continuity condition based on the one or more conditions.

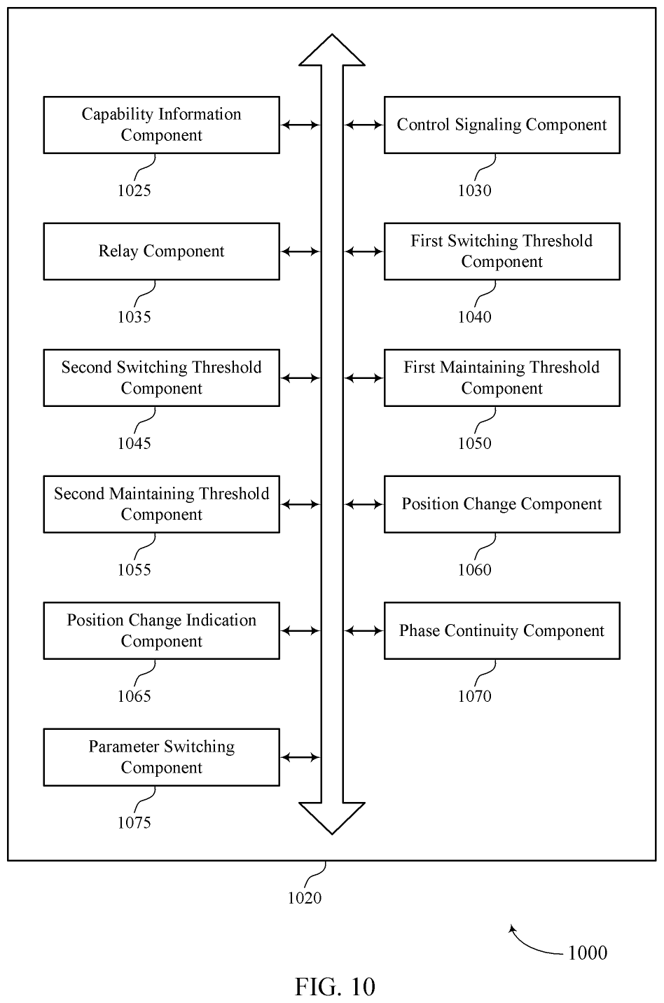

FIG. 10 shows a block diagram 1000 of a communications manager 1020 that supports phase continuity associated with RISs in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of phase continuity associated with reflective surfaces as described herein. For example, the communications manager 1020 may include a capability information component 1025, a control signaling component 1030, a relay component 1035, a first switching threshold component 1040, a second switching threshold component 1045, a first maintaining threshold component 1050, a second maintaining threshold component 1055, a position change component 1060, a position change indication component 1065, a phase continuity component 1070, a parameter switching component 1075, or any combination thereof. Each of these components may communicate, directly or indirectly, with one another (e.g., via one or more buses).

The communications manager 1020 may support wireless communications at a reflective surface in accordance with examples as disclosed herein. The capability information component 1025 may be configured as or otherwise support a means for transmitting capability information indicating a capability to maintain phase continuity across a set of multiple transmissions according to a first set of transmission parameters. The control signaling component 1030 may be configured as or otherwise support a means for receiving, based on the capability information, control signaling indicating one or more conditions under which the reflective surface is to maintain phase continuity. The relay component 1035 may be configured as or otherwise support a means for relaying wireless signaling between at least a first wireless device and a second wireless device according to a phase continuity condition based on the one or more conditions.

In some examples, the first switching threshold component 1040 may be configured as or otherwise support a means for transmitting, in the capability information, an indication of a first threshold time duration in which the reflective surface is capable of switching from a second set of transmission parameters to the first set of transmission parameters. In some examples, the second switching threshold component 1045 may be configured as or otherwise support a means for receiving, in the control signaling, an indication of a second threshold time duration that is greater than or equal to the first threshold time duration, where the one or more conditions indicate that phase continuity is maintained according to the phase continuity condition if the second threshold time duration is satisfied by a timing offset between two transmissions associated with different sets of transmission parameters.

In some examples, to support relaying the wireless signaling, the relay component 1035 may be configured as or otherwise support a means for relaying a first transmission according to the first set of transmission parameters. In some examples, to support relaying the wireless signaling, the relay component 1035 may be configured as or otherwise support a means for relaying a second transmission according to the second set of transmission parameters. In some examples, to support relaying the wireless signaling, the relay component 1035 may be configured as or otherwise support a means for relaying a third transmission according to the first set of transmission parameters, where phase continuity is maintained across the first transmission and the third transmission according to the phase continuity condition based on a timing offset between the second transmission and the third transmission satisfying the second threshold time duration.

In some examples, to support relaying the wireless signaling, the relay component 1035 may be configured as or otherwise support a means for relaying a first transmission according to the first set of transmission parameters. In some examples, to support relaying the wireless signaling, the relay component 1035 may be configured as or otherwise support a means for relaying a second transmission according to the second set of transmission parameters. In some examples, to support relaying the wireless signaling, the relay component 1035 may be configured as or otherwise support a means for relaying a third transmission according to the second set of transmission parameters or a third set of transmission parameters, where phase continuity is not maintained across the first transmission and the third transmission according to the phase continuity condition based on a timing offset between the first transmission and the third transmission failing to satisfy the second threshold time duration.

In some examples, the first maintaining threshold component 1050 may be configured as or otherwise support a means for transmitting, in the capability information, an indication of a first threshold time duration during which the reflective surface is capable of maintaining the first set of transmission parameters. In some examples, the second maintaining threshold component 1055 may be configured as or otherwise support a means for receiving, in the control signaling, an indication of a second threshold time duration that is less than or equal to the first threshold time duration, where the one or more conditions indicate that phase continuity is maintained for one or more transmissions occurring within the second threshold time duration according to the phase continuity condition.

In some examples, the relay component 1035 may be configured as or otherwise support a means for relaying a set of multiple transmissions according to the first set of transmission parameters during the second threshold time duration, where phase continuity is maintained across the set of multiple transmissions according to the phase continuity condition based on the set of multiple transmissions occurring during the second threshold time duration. In some examples, the parameter switching component 1075 may be configured as or otherwise support a means for upon expiration of the second threshold time duration, switching from the first set of transmission parameters to a second set of transmission parameters, where phase continuity is not maintained according to the phase continuity condition after expiration of the second threshold time duration.

In some examples, the position change component 1060 may be configured as or otherwise support a means for changing a position of the reflective surface. In some examples, the position change indication component 1065 may be configured as or otherwise support a means for transmitting an indication that the reflective surface has changed position to one or more of a set of multiple wireless devices including at least a transmitting device and a receiving device. In some examples, the phase continuity component 1070 may be configured as or otherwise support a means for refraining from maintaining phase continuity for subsequent wireless communications between the transmitting device and the receiving device based on changing the position.

In some examples, the position change indication component 1065 may be configured as or otherwise support a means for receiving, from a wireless device of a set of multiple wireless devices, an indication that the wireless device has changed from a first position to a second position. In some examples, the phase continuity component 1070 may be configured as or otherwise support a means for refraining from maintaining phase continuity for subsequent wireless communications between the first wireless device and one or more additional wireless device based on the indication that the wireless device has changed from the first position to the second position.

In some examples, the position change indication component 1065 may be configured as or otherwise support a means for receiving, from the wireless device, an indication that the wireless device has returned to the first position. In some examples, the phase continuity component 1070 may be configured as or otherwise support a means for maintaining phase continuity for one or more additional wireless communications between the first wireless device and the one or more additional wireless devices based on the indication that the wireless device has returned to the first position.

In some examples, the control signaling includes a RRC message, a MAC-CE, a DCI, or any combination thereof, and the first wireless device includes a network entity and the second wireless device includes a UE.

In some examples, the control signaling includes a SCI message, a PSSCH message, a MAC-CE, a sidelink RRC message, or any combination thereof, and the first wireless device includes a first sidelink UE and the second wireless device includes a second sidelink UE.

In some examples, the first set of transmission parameters includes a first transmission beam, a first set of frequency resources, a first transmit power, a first set of antenna ports, a first precoding configuration, or any combination thereof.

In some examples, the capability information includes an indication of a class of reflective surface of a set of multiple classes of reflective surfaces, each class of reflective surfaces associated with a respective set of capabilities.

In some examples, the capability information is associated with a frequency band, a frequency band combination, a carrier, or a carrier combination.

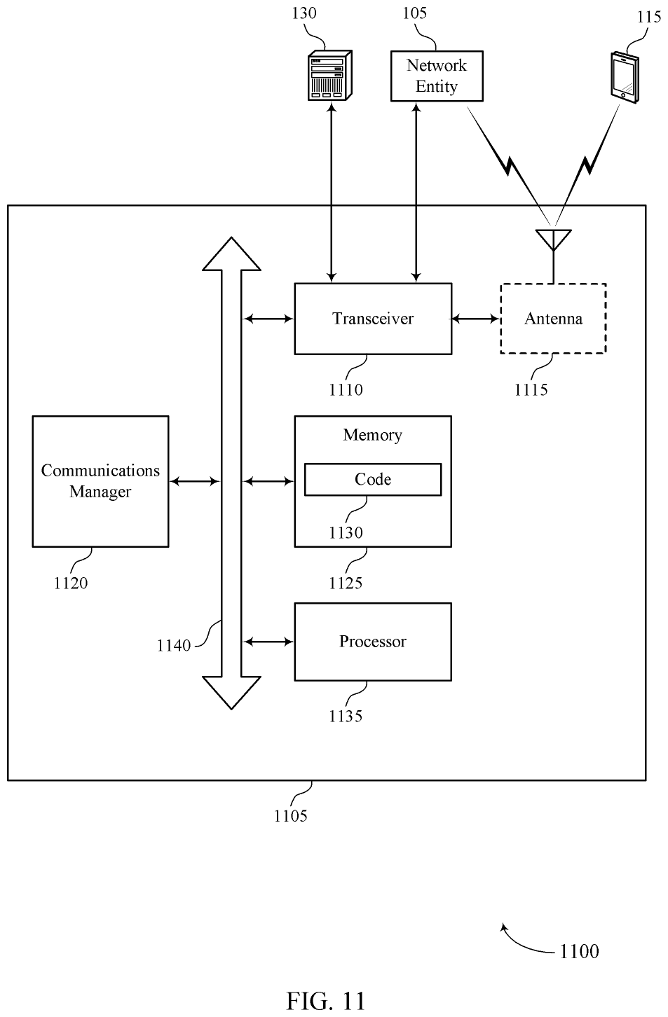

FIG. 11 shows a diagram of a system 1100 including a device 1105 that supports phase continuity associated with RISs in accordance with one or more aspects of the present disclosure. The device 1105 may be an example of or include the components of a device 805, a device 905, or a reflective surface as described herein. The device 1105 may include components for bi-directional voice and data communications including components for transmitting and receiving communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting phase continuity associated with reflective surfaces). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a reflective surface in accordance with examples as disclosed herein. For example, the communications manager 1120 may be configured as or otherwise support a means for transmitting capability information indicating a capability to maintain phase continuity across a set of multiple transmissions according to a first set of transmission parameters. The communications manager 1120 may be configured as or otherwise support a means for receiving, based on the capability information, control signaling indicating one or more conditions under which the reflective surface is to maintain phase continuity. The communications manager 1120 may be configured as or otherwise support a means for relaying wireless signaling between at least a first wireless device and a second wireless device according to a phase continuity condition based on the one or more conditions.

By including or configuring the communications manager 1120 in accordance with examples as described herein, the device 1105 may support techniques for a reflective surface to maintain phase continuity across transmissions, which may lead to improved communication reliability, reduced power consumption, more efficient utilization of communication resources, improved coordination between devices, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of phase continuity associated with reflective surfaces as described herein, or the processor 1135 and the memory 1125 may be otherwise configured to perform or support such operations.

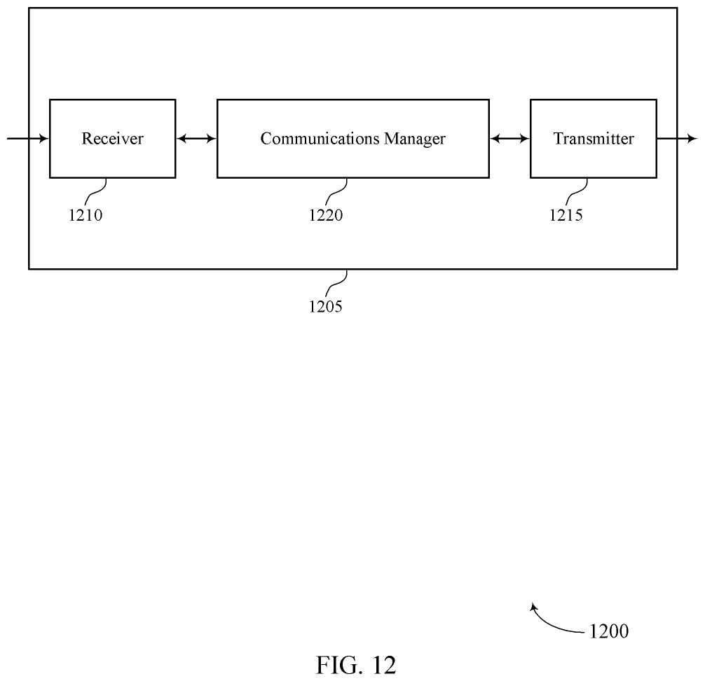

FIG. 12 shows a block diagram 1200 of a device 1205 that supports phase continuity associated with RISs in accordance with one or more aspects of the present disclosure. The device 1205 may be an example of aspects of a UE 115 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to phase continuity associated with reflective surfaces). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to phase continuity associated with reflective surfaces). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of phase continuity associated with reflective surfaces as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a first wireless device in accordance with examples as disclosed herein. For example, the communications manager 1220 may be configured as or otherwise support a means for obtaining, from a reflective surface, capability information indicating a capability of the reflective surface to maintain phase continuity across a set of multiple transmissions according to a first set of transmission parameters. The communications manager 1220 may be configured as or otherwise support a means for outputting, based on the capability information, control signaling indicating one or more conditions under which the reflective surface is to maintain phase continuity. The communications manager 1220 may be configured as or otherwise support a means for transmitting wireless signaling to at least a second wireless device via the reflective surface according to a phase continuity condition based on the one or more conditions.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for a RIS to maintain phase continuity across transmissions, which may lead to reduced processing, reduced power consumption, and more efficient utilization of communication resources).

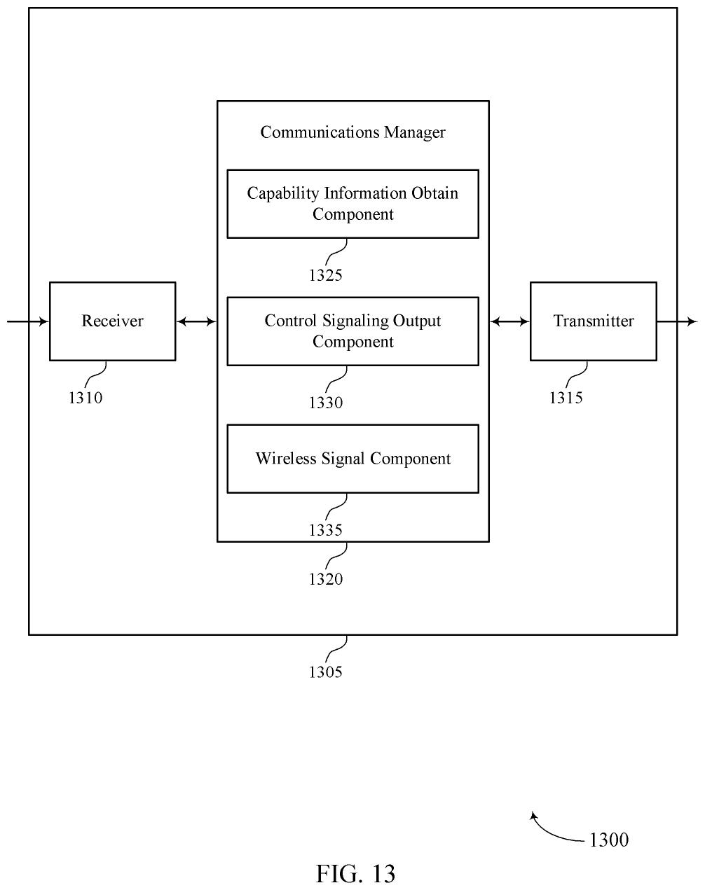

FIG. 13 shows a block diagram 1300 of a device 1305 that supports phase continuity associated with RISs in accordance with one or more aspects of the present disclosure. The device 1305 may be an example of aspects of a device 1205, a UE 115, or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to phase continuity associated with reflective surfaces). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to phase continuity associated with reflective surfaces). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of phase continuity associated with RISs as described herein. For example, the communications manager 1320 may include a capability information component 1325, a control signaling component 1330, a wireless signal component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a first wireless device in accordance with examples as disclosed herein. The capability information component 1325 may be configured as or otherwise support a means for obtaining, from a reflective surface, capability information indicating a capability of the reflective surface to maintain phase continuity across a set of multiple transmissions according to a first set of transmission parameters. The control signaling component 1330 may be configured as or otherwise support a means for outputting, based on the capability information, control signaling indicating one or more conditions under which the reflective surface is to maintain phase continuity. The wireless signal component 1335 may be configured as or otherwise support a means for transmitting wireless signaling to at least a second wireless device via the reflective surface according to a phase continuity condition based on the one or more conditions.

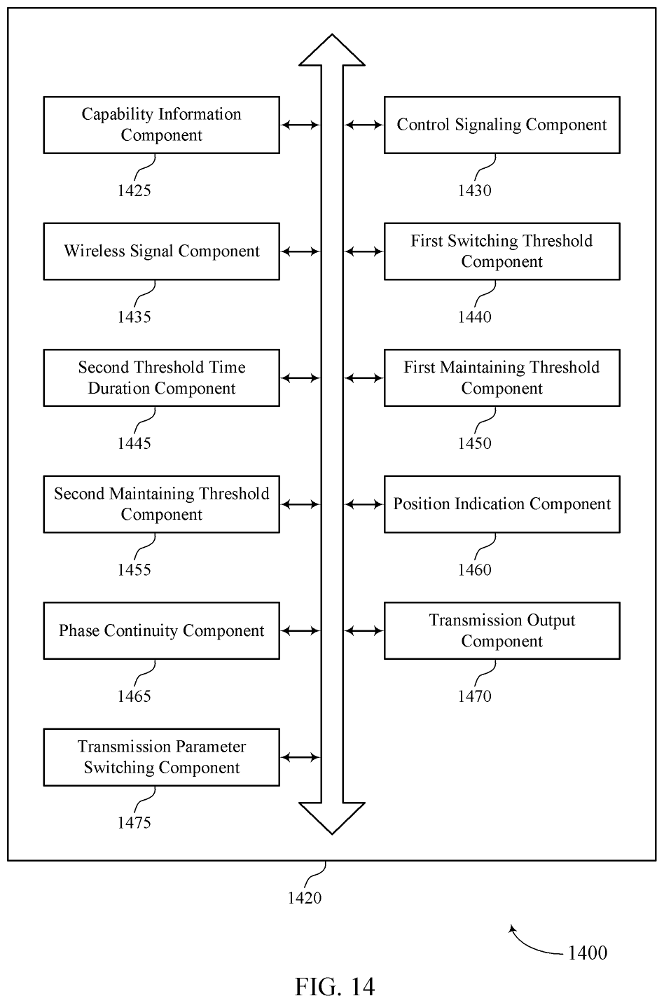

FIG. 14 shows a block diagram 1400 of a communications manager 1420 that supports phase continuity associated with RISs in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of phase continuity associated with reflective surfaces as described herein. For example, the communications manager 1420 may include a capability information component 1425, a control signaling component 1430, a wireless signal component 1435, a first switching threshold component 1440, a second threshold time duration component 1445, a first maintaining threshold component 1450, a second maintaining threshold component 1455, a position indication component 1460, a phase continuity component 1465, a transmission output component 1470, a transmission parameters switching component 1475, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a first wireless device in accordance with examples as disclosed herein. The capability information component 1425 may be configured as or otherwise support a means for obtaining, from a reflective surface, capability information indicating a capability of the reflective surface to maintain phase continuity across a set of multiple transmissions according to a first set of transmission parameters. The control signaling component 1430 may be configured as or otherwise support a means for outputting, based on the capability information, control signaling indicating one or more conditions under which the reflective surface is to maintain phase continuity. The wireless signal component 1435 may be configured as or otherwise support a means for transmitting wireless signaling to at least a second wireless device via the reflective surface according to a phase continuity condition based on the one or more conditions.

In some examples, the first switching threshold component 1440 may be configured as or otherwise support a means for obtaining, in the capability information, an indication of a first threshold time duration in which the reflective surface is capable of switching from a second set of transmission parameters to the first set of transmission parameters. In some examples, the second threshold time duration component 1445 may be configured as or otherwise support a means for outputting, in the control signaling, an indication of a second threshold time duration that is greater than or equal to the first threshold time duration, where the one or more conditions indicate that phase continuity is maintained according to the phase continuity condition if the second threshold time duration is satisfied by a timing offset between two transmissions associated with different sets of transmission parameters.

In some examples, the transmission output component 1470 may be configured as or otherwise support a means for outputting a first transmission associated with the first set of transmission parameters to the second wireless device. In some examples, the transmission output component 1470 may be configured as or otherwise support a means for outputting a second transmission associated with a second set of transmission parameters to a third wireless device. In some examples, the transmission output component 1470 may be configured as or otherwise support a means for outputting a third transmission associated with the first set of transmission parameters to the second wireless device, where phase continuity is maintained across the first transmission and the third transmission according to the phase continuity condition based on a timing offset between the second transmission and the third transmission satisfying the second threshold time duration.

In some examples, the transmission output component 1470 may be configured as or otherwise support a means for outputting a first transmission associated with the first set of transmission parameters to the second wireless device. In some examples, the transmission output component 1470 may be configured as or otherwise support a means for outputting a second transmission associated with a second set of transmission parameters to a third wireless device. In some examples, the transmission output component 1470 may be configured as or otherwise support a means for outputting a third transmission associated with the second set of transmission parameters or a third set of transmission parameters to the second wireless device, where phase continuity is not maintained across the first transmission and the third transmission according to the phase continuity condition based on a timing offset between the second transmission and the third transmission failing to satisfy the second threshold time duration.

In some examples, the first maintaining threshold component 1450 may be configured as or otherwise support a means for obtaining, in the capability information, an indication of a first threshold time duration during which the reflective surface is capable of maintaining the first set of transmission parameters. In some examples, the second maintaining threshold component 1455 may be configured as or otherwise support a means for outputting, in the control signaling, an indication of a second threshold time duration that is less than or equal to the first threshold time duration, where the one or more conditions indicate that phase continuity is maintained for one or more transmissions occurring within the second threshold time duration according to the phase continuity condition.

In some examples, the transmission output component 1470 may be configured as or otherwise support a means for outputting a set of multiple transmissions associated with the first set of transmission parameters during the second threshold time duration, where phase continuity is maintained across the set of multiple transmissions according to the phase continuity condition based on the set of multiple transmissions occurring during the second threshold time duration. In some examples, the transmission parameters switching component 1475 may be configured as or otherwise support a means for upon expiration of the second threshold time duration, switching from the first set of transmission parameters to a second set of transmission parameters, where phase continuity is not maintained according to the phase continuity condition after expiration of the second threshold time duration.

In some examples, the control signaling component 1430 may be configured as or otherwise support a means for outputting control signaling indicating to the second wireless device indicating the one or more conditions under which the reflective surface is to maintain phase continuity.

In some examples, the position indication component 1460 may be configured as or otherwise support a means for obtaining an indication that the reflective surface has changed position. In some examples, the phase continuity component 1465 may be configured as or otherwise support a means for refraining from maintaining phase continuity for subsequent wireless communications between the first wireless device and one or more additional wireless devices based on obtaining the indication that the reflective surface has changed position.

In some examples, the position indication component 1460 may be configured as or otherwise support a means for outputting, to the second wireless device, the obtained indication that the reflective surface has changed position.

In some examples, the position indication component 1460 may be configured as or otherwise support a means for outputting, to the reflective surface, an indication that at least one of the first wireless device or the second wireless device has changed from a first position to a second position. In some examples, the phase continuity component 1465 may be configured as or otherwise support a means for refraining from maintaining phase continuity for subsequent wireless communications between the first wireless device and the second wireless device based on the indication that the at least one of the first wireless device or the second wireless device has changed from the first position to the second position.

In some examples, the position indication component 1460 may be configured as or otherwise support a means for outputting, to the reflective surface, an indication that at least one of the first wireless device or the second wireless device has returned to the first position. In some examples, the phase continuity component 1465 may be configured as or otherwise support a means for maintaining phase continuity for one or more additional wireless communications between the first wireless device and the second wireless device based on the indication that the at least one of the first wireless device or the second wireless device has returned to the first position.

In some examples, the control signaling includes a RRC message, a MAC-CE, a DCI, or any combination thereof, and the first wireless device includes a network entity and the second wireless device includes a UE.

In some examples, the control signaling includes a SCI message, a PSSCH, a MAC-CE, a SCI message, or any combination thereof, and the first wireless device includes a first sidelink UE and the second wireless device includes a second sidelink UE.

In some examples, the capability information includes an indication of a class of RIS of a set of multiple classes of reflective surfaces, each class of reflective surfaces associated with a respective set of capabilities.

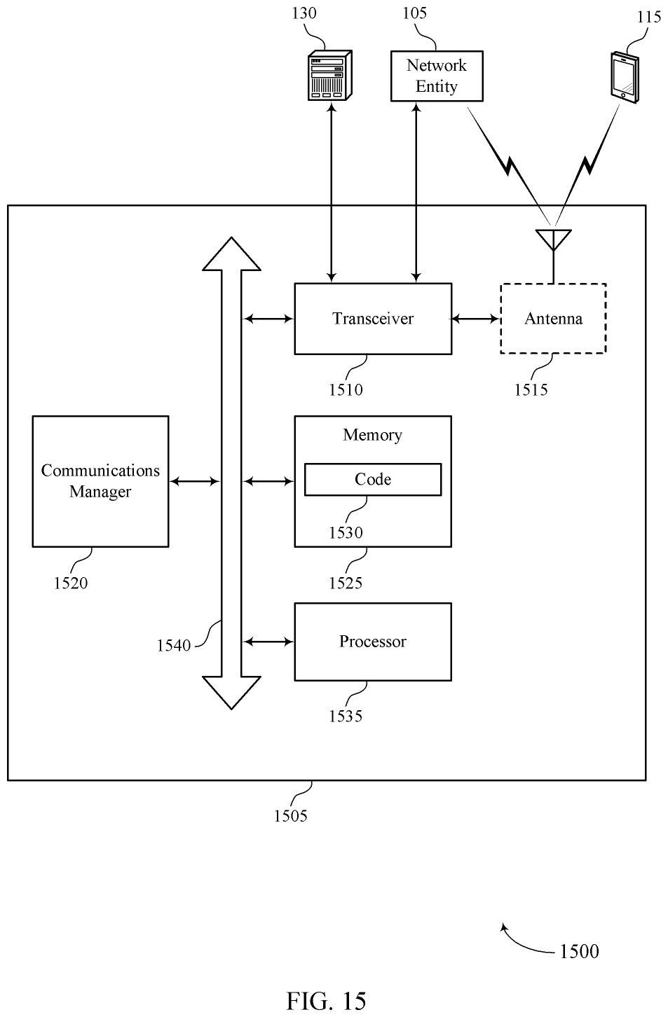

FIG. 15 shows a diagram of a system 1500 including a device 1505 that supports phase continuity associated with RISs in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include random access memory (RAM) and read-only memory (ROM). The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a basic input/output (I/O) system (BIOS) which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting phase continuity associated with RISs). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem.

Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at a first wireless device in accordance with examples as disclosed herein. For example, the communications manager 1520 may be configured as or otherwise support a means for obtaining, from a reflective surface, capability information indicating a capability of the reflective surface to maintain phase continuity across a set of multiple transmissions according to a first set of transmission parameters. The communications manager 1520 may be configured as or otherwise support a means for outputting, based on the capability information, control signaling indicating one or more conditions under which the reflective surface is to maintain phase continuity. The communications manager 1520 may be configured as or otherwise support a means for transmitting wireless signaling to at least a second wireless device via the reflective surface according to a phase continuity condition based on the one or more conditions.

By including or configuring the communications manager 1520 in accordance with examples as described herein, the device 1505 may support techniques for a reflective surface to maintain phase continuity, which may include improved communication reliability, reduced power consumption, and more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of phase continuity associated with reflective surfaces as described herein, or the processor 1535 and the memory 1525 may be otherwise configured to perform or support such operations.

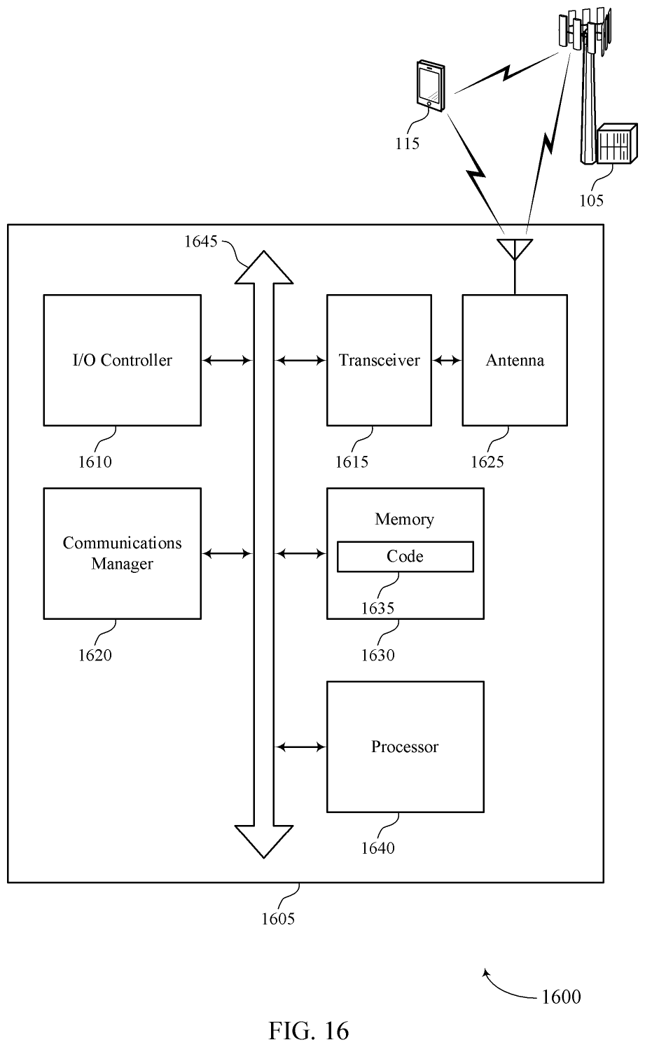

FIG. 16 shows a diagram of a system 1600 including a device 1605 that supports phase continuity associated with RISs in accordance with one or more aspects of the present disclosure. The device 1605 may be an example of or include the components of a device 1205, a device 1305, or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an I/O controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®), or another known operating system. Additionally, or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions.

The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1215, a transmitter 1315, a receiver 1210, a receiver 1310, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting phase continuity associated with reflective surfaces). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communications at a first wireless device in accordance with examples as disclosed herein. For example, the communications manager 1620 may be configured as or otherwise support a means for obtaining, from a reflective surface, capability information indicating a capability of the reflective surface to maintain phase continuity across a set of multiple transmissions according to a first set of transmission parameters. The communications manager 1620 may be configured as or otherwise support a means for outputting, based on the capability information, control signaling indicating one or more conditions under which the reflective surface is to maintain phase continuity. The communications manager 1620 may be configured as or otherwise support a means for transmitting wireless signaling to at least a second wireless device via the reflective surface according to a phase continuity condition based on the one or more conditions.

By including or configuring the communications manager 1620 in accordance with examples as described herein, the device 1605 may support techniques for a reflective surface to maintain phase continuity across transmissions, which may lead to reduced power consumption and more efficient utilization of communication resources.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of phase continuity associated with reflective surfaces as described herein, or the processor 1640 and the memory 1630 may be otherwise configured to perform or support such operations.

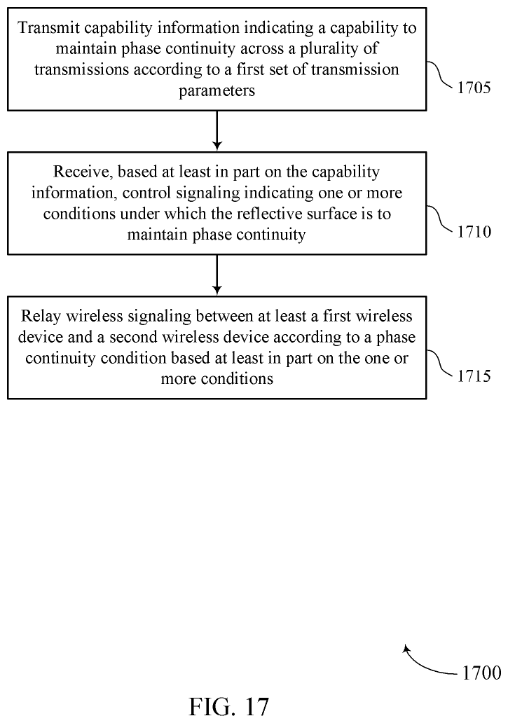

FIG. 17 shows a flowchart illustrating a method 1700 that supports phase continuity associated with RISs in accordance with one or more aspects of the present disclosure. The operations of the method 1700 may be implemented by a reflective surface or its components as described herein. For example, the operations of the method 1700 may be performed by a reflective surface as described with reference to FIGS. 1 through 11. In some examples, a reflective surface may execute a set of instructions to control the functional elements of the reflective surface to perform the described functions. Additionally, or alternatively, the reflective surface may perform aspects of the described functions using special-purpose hardware.

At 1705, the method may include transmitting capability information indicating a capability to maintain phase continuity across a set of multiple transmissions according to a first set of transmission parameters. The operations of 1705 may be performed in accordance with examples as disclosed herein. In some examples, aspects of the operations of 1705 may be performed by a capability information component 1025 as described with reference to FIG. 10.

At 1710, the method may include receiving, based on the capability information, control signaling indicating one or more conditions under which the reflective surface is to maintain phase continuity. The operations of 1710 may be performed in accordance with examples as disclosed herein. In some examples, aspects of the operations of 1710 may be performed by a control signaling component 1030 as described with reference to FIG. 10.

At 1715, the method may include relaying wireless signaling between at least a first wireless device and a second wireless device according to a phase continuity condition based on the one or more conditions. The operations of 1715 may be performed in accordance with examples as disclosed herein. In some examples, aspects of the operations of 1715 may be performed by a relay component 1035 as described with reference to FIG. 10.

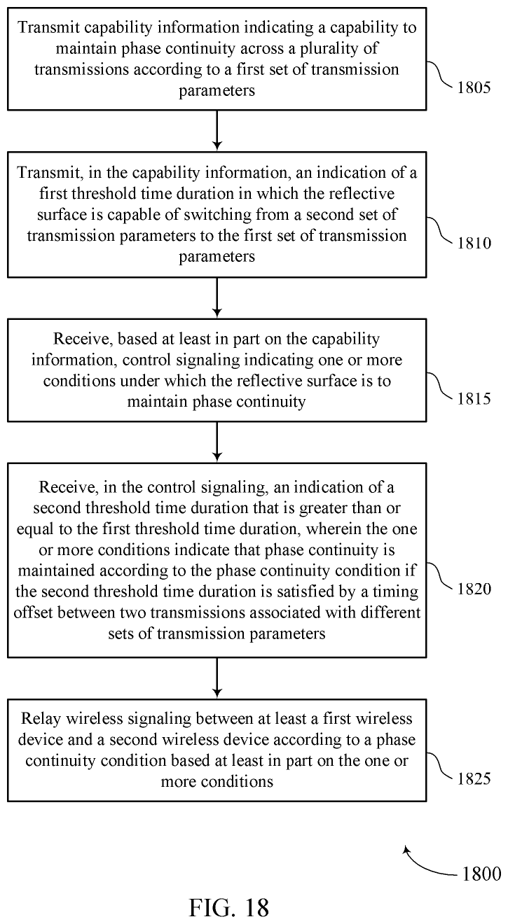

FIG. 18 shows a flowchart illustrating a method 1800 that supports phase continuity associated with reflective surfaces in accordance with one or more aspects of the present disclosure. The operations of the method 1800 may be implemented by a reflective surface or its components as described herein. For example, the operations of the method 1800 may be performed by a reflective surface as described with reference to FIGS. 1 through 11. In some examples, a reflective surface may execute a set of instructions to control the functional elements of the reflective surface to perform the described functions. Additionally, or alternatively, the reflective surface may perform aspects of the described functions using special-purpose hardware.

At 1805, the method may include transmitting capability information indicating a capability to maintain phase continuity across a set of multiple transmissions according to a first set of transmission parameters. The operations of 1805 may be performed in accordance with examples as disclosed herein. In some examples, aspects of the operations of 1805 may be performed by a capability information component 1025 as described with reference to FIG. 10.

At 1810, the method may include transmitting, in the capability information, an indication of a first threshold time duration in which the reflective surface is capable of switching from a second set of transmission parameters to the first set of transmission parameters. The operations of 1810 may be performed in accordance with examples as disclosed herein. In some examples, aspects of the operations of 1810 may be performed by a first switching threshold component 1040 as described with reference to FIG. 10.

At 1815, the method may include receiving, based on the capability information, control signaling indicating one or more conditions under which the reflective surface is to maintain phase continuity. The operations of 1815 may be performed in accordance with examples as disclosed herein. In some examples, aspects of the operations of 1815 may be performed by a control signaling component 1030 as described with reference to FIG. 10.

At 1820, the method may include receiving, in the control signaling, an indication of a second threshold time duration that is greater than or equal to the first threshold time duration, where the one or more conditions indicate that phase continuity is maintained according to the phase continuity condition if the second threshold time duration is satisfied by a timing offset between two transmissions associated with different sets of transmission parameters. The operations of 1820 may be performed in accordance with examples as disclosed herein. In some examples, aspects of the operations of 1820 may be performed by a second switching threshold component 1045 as described with reference to FIG. 10.

At 1825, the method may include relaying wireless signaling between at least a first wireless device and a second wireless device according to a phase continuity condition based on the one or more conditions. The operations of 1825 may be performed in accordance with examples as disclosed herein. In some examples, aspects of the operations of 1825 may be performed by a relay component 1035 as described with reference to FIG. 10.

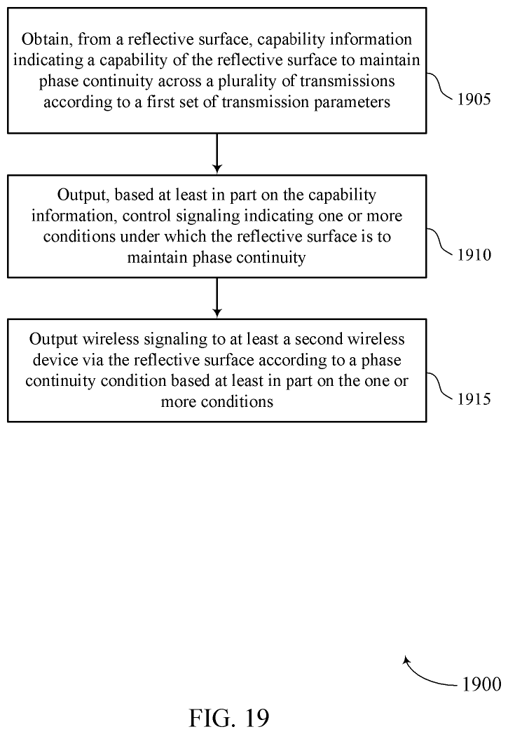

FIG. 19 shows a flowchart illustrating a method 1900 that supports phase continuity associated with reflective surfaces in accordance with one or more aspects of the present disclosure. The operations of the method 1900 may be implemented by a network entity or a UE or its components as described herein. For example, the operations of the method 1900 may be performed by a network entity or a UE 115 as described with reference to FIGS. 1 through 7 and 12 through 16. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1905, the method may include obtaining, from a reflective surface, capability information indicating a capability of the reflective surface to maintain phase continuity across a set of multiple transmissions according to a first set of transmission parameters. The operations of 1905 may be performed in accordance with examples as disclosed herein. In some examples, aspects of the operations of 1905 may be performed by a capability information component 1425 as described with reference to FIG. 14.

At 1910, the method may include outputting, based on the capability information, control signaling indicating one or more conditions under which the reflective surface is to maintain phase continuity. The operations of 1910 may be performed in accordance with examples as disclosed herein. In some examples, aspects of the operations of 1910 may be performed by a control signaling component 1430 as described with reference to FIG. 14.

At 1915, the method may include transmitting wireless signaling to at least a second wireless device via the reflective surface according to a phase continuity condition based on the one or more conditions. The operations of 1915 may be performed in accordance with examples as disclosed herein. In some examples, aspects of the operations of 1915 may be performed by a wireless signal component 1435 as described with reference to FIG. 14.

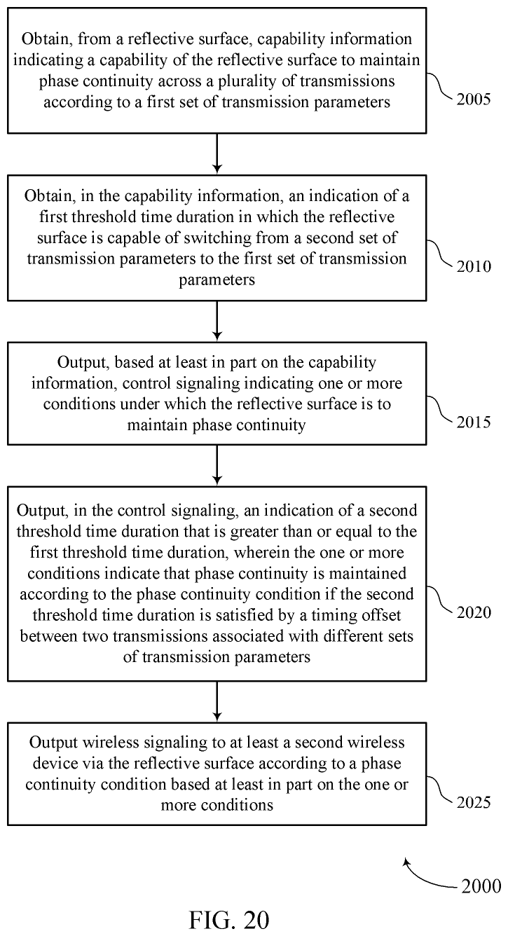

FIG. 20 shows a flowchart illustrating a method 2000 that supports phase continuity associated with RISs in accordance with one or more aspects of the present disclosure. The operations of the method 2000 may be implemented by a network entity or a UE or its components as described herein. For example, the operations of the method 2000 may be performed by a network entity or a UE 115 as described with reference to FIGS. 1 through 7 and 12 through 16. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 2005, the method may include obtaining, from a reflective surface, capability information indicating a capability of the reflective surface to maintain phase continuity across a set of multiple transmissions according to a first set of transmission parameters. The operations of 2005 may be performed in accordance with examples as disclosed herein. In some examples, aspects of the operations of 2005 may be performed by a capability information component 1425 as described with reference to FIG. 14.

At 2010, the method may include obtaining, in the capability information, an indication of a first threshold time duration in which the reflective surface is capable of switching from a second set of transmission parameters to the first set of transmission parameters. The operations of 2010 may be performed in accordance with examples as disclosed herein. In some examples, aspects of the operations of 2010 may be performed by a first switching threshold component 1440 as described with reference to FIG. 14.

At 2015, the method may include outputting, based on the capability information, control signaling indicating one or more conditions under which the reflective surface is to maintain phase continuity. The operations of 2015 may be performed in accordance with examples as disclosed herein. In some examples, aspects of the operations of 2015 may be performed by a control signaling component 1430 as described with reference to FIG. 14.

At 2020, the method may include outputting, in the control signaling, an indication of a second threshold time duration that is greater than or equal to the first threshold time duration, where the one or more conditions indicate that phase continuity is maintained according to the phase continuity condition if the second threshold time duration is satisfied by a timing offset between two transmissions associated with different sets of transmission parameters. The operations of 2020 may be performed in accordance with examples as disclosed herein. In some examples, aspects of the operations of 2020 may be performed by a second threshold time duration component 1445 as described with reference to FIG. 14.

At 2025, the method may include transmitting wireless signaling to at least a second wireless device via the reflective surface according to a phase continuity condition based on the one or more conditions. The operations of 2025 may be performed in accordance with examples as disclosed herein. In some examples, aspects of the operations of 2025 may be performed by a wireless signal component 1435 as described with reference to FIG. 14.

The following provides an overview of aspects of the present disclosure:

Aspect 1: A method for wireless communications at a reflective surface, comprising: transmitting capability information indicating a capability to maintain phase continuity across a plurality of transmissions according to a first set of transmission parameters; receiving, based at least in part on the capability information, control signaling indicating one or more conditions under which the reflective surface is to maintain phase continuity; and relaying wireless signaling between at least a first wireless device and a second wireless device according to a phase continuity condition based at least in part on the one or more conditions.

Aspect 2: The method of aspect 1, further comprising: transmitting, in the capability information, an indication of a first threshold time duration in which the reflective surface is capable of switching from a second set of transmission parameters to the first set of transmission parameters; and receiving, in the control signaling, an indication of a second threshold time duration that is greater than or equal to the first threshold time duration, wherein the one or more conditions indicate that phase continuity is maintained according to the phase continuity condition if the second threshold time duration is satisfied by a timing offset between two transmissions associated with different sets of transmission parameters.

Aspect 3: The method of aspect 2, wherein relaying the wireless signaling comprises: relaying a first transmission according to the first set of transmission parameters; relaying a second transmission according to the second set of transmission parameters; and relaying a third transmission according to the first set of transmission parameters, wherein phase continuity is maintained across the first transmission and the third transmission according to the phase continuity condition based at least in part on a timing offset between the second transmission and the third transmission satisfying the second threshold time duration.

Aspect 4: The method of any of aspects 2 through 3, wherein relaying the wireless signaling comprises: relaying a first transmission according to the first set of transmission parameters; relaying a second transmission according to the second set of transmission parameters; and relaying a third transmission according to the second set of transmission parameters or a third set of transmission parameters, wherein phase continuity is not maintained across the first transmission and the third transmission according to the phase continuity condition based at least in part on a timing offset between the first transmission and the third transmission failing to satisfy the second threshold time duration.

Aspect 5: The method of any of aspects 1 through 4, further comprising: transmitting, in the capability information, an indication of a first threshold time duration during which the reflective surface is capable of maintaining the first set of transmission parameters; and receiving, in the control signaling, an indication of a second threshold time duration that is less than or equal to the first threshold time duration, wherein the one or more conditions indicate that phase continuity is maintained for one or more transmissions occurring within the second threshold time duration according to the phase continuity condition.

Aspect 6: The method of aspect 5, further comprising: relaying a plurality of transmissions according to the first set of transmission parameters during the second threshold time duration, wherein phase continuity is maintained across the plurality of transmissions according to the phase continuity condition based at least in part on the plurality of transmissions occurring during the second threshold time duration; and upon expiration of the second threshold time duration, switching from the first set of transmission parameters to a second set of transmission parameters, wherein phase continuity is not maintained according to the phase continuity condition after expiration of the second threshold time duration.

Aspect 7: The method of any of aspects 1 through 6, further comprising: changing a position of the reflective surface; transmitting an indication that the reflective surface has changed position to one or more of a plurality of wireless devices comprising at least a transmitting device and a receiving device; and refraining from maintaining phase continuity for subsequent wireless communications between the transmitting device and the receiving device based at least in part on changing the position.

Aspect 8: The method of any of aspects 1 through 7, further comprising: receiving, from a wireless device of a plurality of wireless devices, an indication that the wireless device has changed from a first position to a second position; and refraining from maintaining phase continuity for subsequent wireless communications between the first wireless device and one or more additional wireless device based at least in part on the indication that the wireless device has changed from the first position to the second position.

Aspect 9: The method of aspect 8, further comprising: receiving, from the wireless device, an indication that the wireless device has returned to the first position; and maintaining phase continuity for one or more additional wireless communications between the first wireless device and the one or more additional wireless devices based at least in part on the indication that the wireless device has returned to the first position.

Aspect 10: The method of any of aspects 1 through 9, wherein the control signaling comprises a radio resource control message, a media access control control element, a downlink control information, or any combination thereof, and the first wireless device comprises a network entity and the second wireless device comprises a UE.

Aspect 11: The method of any of aspects 1 through 10, wherein the control signaling comprises a sidelink control information message, a physical sidelink shared channel message, a media access control control element, a sidelink radio resource control message, or any combination thereof, and the first wireless device comprises a first sidelink UE and the second wireless device comprises a second sidelink UE.

Aspect 12: The method of any of aspects 1 through 11, wherein the first set of transmission parameters comprises a first transmission beam, a first set of frequency resources, a first transmit power, a first set of antenna ports, a first precoding configuration, or any combination thereof.

Aspect 13: The method of any of aspects 1 through 12, wherein the capability information comprises an indication of a class of reflective surface of a plurality of classes of reflective surfaces, each class of reflective surfaces associated with a respective set of capabilities.

Aspect 14: The method of any of aspects 1 through 13, wherein the capability information is associated with a frequency band, a frequency band combination, a carrier, or a carrier combination.

Aspect 15: A method for wireless communications at a first wireless device, comprising: obtaining, from a reflective surface, capability information indicating a capability of the reflective surface to maintain phase continuity across a plurality of transmissions according to a first set of transmission parameters; outputting, based at least in part on the capability information, control signaling indicating one or more conditions under which the reflective surface is to maintain phase continuity; and transmitting wireless signaling to at least a second wireless device via the reflective surface according to a phase continuity condition based at least in part on the one or more conditions.

Aspect 16: The method of aspect 15, further comprising: obtaining, in the capability information, an indication of a first threshold time duration in which the reflective surface is capable of switching from a second set of transmission parameters to the first set of transmission parameters; and outputting, in the control signaling, an indication of a second threshold time duration that is greater than or equal to the first threshold time duration, wherein the one or more conditions indicate that phase continuity is maintained according to the phase continuity condition if the second threshold time duration is satisfied by a timing offset between two transmissions associated with different sets of transmission parameters.

Aspect 17: The method of aspect 16, further comprising: outputting a first transmission associated with the first set of transmission parameters to the second wireless device; outputting a second transmission associated with a second set of transmission parameters to a third wireless device; and outputting a third transmission associated with the first set of transmission parameters to the second wireless device, wherein phase continuity is maintained across the first transmission and the third transmission according to the phase continuity condition based at least in part on a timing offset between the second transmission and the third transmission satisfying the second threshold time duration.

Aspect 18: The method of any of aspects 16 through 17, further comprising: outputting a first transmission associated with the first set of transmission parameters to the second wireless device; outputting a second transmission associated with a second set of transmission parameters to a third wireless device; and outputting a third transmission associated with the second set of transmission parameters or a third set of transmission parameters to the second wireless device, wherein phase continuity is not maintained across the first transmission and the third transmission according to the phase continuity condition based at least in part on a timing offset between the second transmission and the third transmission failing to satisfy the second threshold time duration.

Aspect 19: The method of any of aspects 15 through 18, further comprising: obtaining, in the capability information, an indication of a first threshold time duration during which the reflective surface is capable of maintaining the first set of transmission parameters; and outputting, in the control signaling, an indication of a second threshold time duration that is less than or equal to the first threshold time duration, wherein the one or more conditions indicate that phase continuity is maintained for one or more transmissions occurring within the second threshold time duration according to the phase continuity condition.

Aspect 20: The method of aspect 19, further comprising: outputting a plurality of transmissions associated with the first set of transmission parameters during the second threshold time duration, wherein phase continuity is maintained across the plurality of transmissions according to the phase continuity condition based at least in part on the plurality of transmissions occurring during the second threshold time duration; and upon expiration of the second threshold time duration, switching from the first set of transmission parameters to a second set of transmission parameters, wherein phase continuity is not maintained according to the phase continuity condition after expiration of the second threshold time duration.

Aspect 21: The method of any of aspects 15 through 20, further comprising: outputting control signaling indicating to the second wireless device indicating the one or more conditions under which the reflective surface is to maintain phase continuity.

Aspect 22: The method of any of aspects 15 through 21, further comprising: obtaining an indication that the reflective surface has changed position; and refraining from maintaining phase continuity for subsequent wireless communications between the first wireless device and one or more additional wireless devices based at least in part on obtaining the indication that the reflective surface has changed position.

Aspect 23: The method of aspect 22, further comprising: outputting, to the second wireless device, the obtained indication that the reflective surface has changed position.

Aspect 24: The method of any of aspects 15 through 23, further comprising: outputting, to the reflective surface, an indication that at least one of the first wireless device or the second wireless device has changed from a first position to a second position; and refraining from maintaining phase continuity for subsequent wireless communications between the first wireless device and the second wireless device based at least in part on the indication that the at least one of the first wireless device or the second wireless device has changed from the first position to the second position.

Aspect 25: The method of aspect 24, further comprising: outputting, to the reflective surface, an indication that at least one of the first wireless device or the second wireless device has returned to the first position; and maintaining phase continuity for one or more additional wireless communications between the first wireless device and the second wireless device based at least in part on the indication that the at least one of the first wireless device or the second wireless device has returned to the first position.

Aspect 26: The method of any of aspects 15 through 25, wherein the control signaling comprises a radio resource control message, a media access control (MAC) control element (MAC-CE), a downlink control information, or any combination thereof, and the first wireless device comprises a network entity and the second wireless device comprises a UE.

Aspect 27: The method of any of aspects 15 through 26, wherein the control signaling comprises a sidelink control information message, a physical sidelink shared channel message, a media access control (MAC) control element (MAC-CE), a sidelink radio resource control message, or any combination thereof, and the first wireless device comprises a first sidelink UE and the second wireless device comprises a second sidelink UE.

Aspect 28: The method of any of aspects 15 through 27, wherein the capability information comprises an indication of a class of reflective surface of a plurality of classes of reflective surfaces, each class of reflective surfaces associated with a respective set of capabilities.

Aspect 29: An apparatus for wireless communications at a reflective surface, comprising a processor; memory coupled with the processor; and instructions stored in the memory and executable by the processor to cause the apparatus to perform a method of any of aspects 1 through 14.

Aspect 30: An apparatus for wireless communications at a reflective surface, comprising at least one means for performing a method of any of aspects 1 through 14.

Aspect 31: A non-transitory computer-readable medium storing code for wireless communications at a reflective surface, the code comprising instructions executable by a processor to perform a method of any of aspects 1 through 14.

Aspect 32: An apparatus for wireless communications at a first wireless device, comprising a processor; memory coupled with the processor; and instructions stored in the memory and executable by the processor to cause the apparatus to perform a method of any of aspects 15 through 28.

Aspect 33: An apparatus for wireless communications at a first wireless device, comprising at least one means for performing a method of any of aspects 15 through 28.

Aspect 34: A non-transitory computer-readable medium storing code for wireless communications at a first wireless device, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a reflective surface, comprising:
a processor;
memory in electronic communication with the processor; and
instructions stored in the memory, wherein the instructions are executable by the processor to:
transmit capability information indicating a capability to maintain phase continuity across a plurality of transmissions according to a first set of transmission parameters;
receive, based at least in part on the capability information, control signaling indicating one or more conditions under which the reflective surface is to maintain phase continuity; and
relay wireless signaling between at least a first wireless device and a second wireless device according to a phase continuity condition based at least in part on the one or more conditions.

2. The apparatus of claim 1, wherein the instructions are further executable by the processor to:
transmit, in the capability information, an indication of a first threshold time duration in which the reflective surface is capable of switching from a second set of transmission parameters to the first set of transmission parameters; and
receive, in the control signaling, an indication of a second threshold time duration that is greater than or equal to the first threshold time duration, wherein the one or more conditions indicate that phase continuity is maintained according to the phase continuity condition if the second threshold time duration is satisfied by a timing offset between two transmissions associated with different sets of transmission parameters.

3. The apparatus of claim 2, wherein the instructions executable by the processor to relay the wireless signaling comprise instructions executable by the processor to:
relay a first transmission according to the first set of transmission parameters;
relay a second transmission according to the second set of transmission parameters; and
relay a third transmission according to the first set of transmission parameters, wherein phase continuity is maintained across the first transmission and the third transmission according to the phase continuity condition based at least in part on a timing offset between the second transmission and the third transmission satisfying the second threshold time duration.

4. The apparatus of claim 2, wherein the instructions executable by the processor to relay the wireless signaling comprise instructions executable by the processor to:
relay a first transmission according to the first set of transmission parameters;
relay a second transmission according to the second set of transmission parameters; and
relay a third transmission according to the second set of transmission parameters or a third set of transmission parameters, wherein phase continuity is not maintained across the first transmission and the third transmission according to the phase continuity condition based at least in part on a timing offset between the first transmission and the third transmission failing to satisfy the second threshold time duration.

5. The apparatus of claim 1, wherein the instructions are further executable by the processor to:
transmit, in the capability information, an indication of a first threshold time duration during which the reflective surface is capable of maintaining the first set of transmission parameters; and
receive, in the control signaling, an indication of a second threshold time duration that is less than or equal to the first threshold time duration, wherein the one or more conditions indicate that phase continuity is maintained for one or more transmissions occurring within the second threshold time duration according to the phase continuity condition.

6. The apparatus of claim 5, wherein the instructions are further executable by the processor to:
relay a plurality of transmissions according to the first set of transmission parameters during the second threshold time duration, wherein phase continuity is maintained across the plurality of transmissions according to the phase continuity condition based at least in part on the plurality of transmissions occurring during the second threshold time duration; and
upon expiration of the second threshold time duration, switch from the first set of transmission parameters to a second set of transmission parameters, wherein phase continuity is not maintained according to the phase continuity condition after expiration of the second threshold time duration.

7. The apparatus of claim 1, wherein the instructions are further executable by the processor to:
change a position of the reflective surface;
transmit an indication that the reflective surface has changed position to one or more of a plurality of wireless devices comprising at least a transmitting device and a receiving device; and
refrain from maintaining phase continuity for subsequent wireless communications between the transmitting device and the receiving device based at least in part on changing the position.

8. The apparatus of claim 1, wherein the instructions are further executable by the processor to:
receive, from a wireless device of a plurality of wireless devices, an indication that the wireless device has changed from a first position to a second position; and
refrain from maintaining phase continuity for subsequent wireless communications between the first wireless device and one or more additional wireless device based at least in part on the indication that the wireless device has changed from the first position to the second position.

9. The apparatus of claim 8, wherein the instructions are further executable by the processor to:
receive, from the wireless device, an indication that the wireless device has returned to the first position; and
maintain phase continuity for one or more additional wireless communications between the first wireless device and the one or more additional wireless devices based at least in part on the indication that the wireless device has returned to the first position.

10. The apparatus of claim 1, wherein the control signaling comprises a radio resource control message, a media access control (MAC) control element (MAC-CE), a downlink control information, or any combination thereof, and the first wireless device comprises a network entity and the second wireless device comprises a user equipment (UE).

11. The apparatus of claim 1, wherein the control signaling comprises a sidelink control information message, a physical sidelink shared channel message, a media access control (MAC) control element (MAC-CE), a sidelink radio resource control message, or any combination thereof, and the first wireless device comprises a first sidelink user equipment (UE) and the second wireless device comprises a second sidelink UE.

12. The apparatus of claim 1, wherein the first set of transmission parameters comprises a first transmission beam, a first set of frequency resources, a first transmit power, a first set of antenna ports, a first precoding configuration, or any combination thereof.

13. The apparatus of claim 1, wherein the capability information comprises an indication of a class of reflective surface of a plurality of classes of reflective surfaces, each class of reflective surfaces associated with a respective set of capabilities.

14. The apparatus of claim 1, wherein the capability information is associated with a frequency band, a frequency band combination, a carrier, or a carrier combination.

15. The apparatus of claim 1, wherein the reflective surface comprises a reconfigurable intelligent surface, an amplify-and-forward relay, a radio frequency identification tag, or any combination thereof.

16. An apparatus for wireless communications at a first wireless device, comprising:
a processor;
memory in electronic communication with the processor; and
instructions stored in the memory, wherein the instructions are executable by the processor to:
obtain, from a reflective surface, capability information indicating a capability of the reflective surface to maintain phase continuity across a plurality of transmissions according to a first set of transmission parameters;
output, based at least in part on the capability information, control signaling indicating one or more conditions under which the reflective surface is to maintain phase continuity; and
output wireless signaling to at least a second wireless device via the reflective surface according to a phase continuity condition based at least in part on the one or more conditions.

17. The apparatus of claim 16, wherein the instructions are further executable by the processor to:
obtain, in the capability information, an indication of a first threshold time duration in which the reflective surface is capable of switching from a second set of transmission parameters to the first set of transmission parameters; and
output, in the control signaling, an indication of a second threshold time duration that is greater than or equal to the first threshold time duration, wherein the one or more conditions indicate that phase continuity is maintained according to the phase continuity condition if the second threshold time duration is satisfied by a timing offset between two transmissions associated with different sets of transmission parameters.

18. The apparatus of claim 17, wherein the instructions are further executable by the processor to:
output a first transmission associated with the first set of transmission parameters to the second wireless device;
output a second transmission associated with a second set of transmission parameters to a third wireless device; and
output a third transmission associated with the first set of transmission parameters to the second wireless device, wherein phase continuity is maintained across the first transmission and the third transmission according to the phase continuity condition based at least in part on a timing offset between the second transmission and the third transmission satisfying the second threshold time duration.

19. The apparatus of claim 17, wherein the instructions are further executable by the processor to:
output a first transmission associated with the first set of transmission parameters to the second wireless device;
output a second transmission associated with a second set of transmission parameters to a third wireless device; and
output a third transmission associated with the second set of transmission parameters or a third set of transmission parameters to the second wireless device, wherein phase continuity is not maintained across the first transmission and the third transmission according to the phase continuity condition based at least in part on a timing offset between the second transmission and the third transmission failing to satisfy the second threshold time duration.

20. The apparatus of claim 16, wherein the instructions are further executable by the processor to:
obtain, in the capability information, an indication of a first threshold time duration during which the reflective surface is capable of maintaining the first set of transmission parameters; and
output, in the control signaling, an indication of a second threshold time duration that is less than or equal to the first threshold time duration, wherein the one or more conditions indicate that phase continuity is maintained for one or more transmissions occurring within the second threshold time duration according to the phase continuity condition.

21. The apparatus of claim 20, wherein the instructions are further executable by the processor to:
output a plurality of transmissions associated with the first set of transmission parameters during the second threshold time duration, wherein phase continuity is maintained across the plurality of transmissions according to the phase continuity condition based at least in part on the plurality of transmissions occurring during the second threshold time duration; and
upon expiration of the second threshold time duration, switch from the first set of transmission parameters to a second set of transmission parameters, wherein phase continuity is not maintained according to the phase continuity condition after expiration of the second threshold time duration.

22. The apparatus of claim 16, wherein the instructions are further executable by the processor to:
output control signaling indicating to the second wireless device indicating the one or more conditions under which the reflective surface is to maintain phase continuity.

23. The apparatus of claim 16, wherein the instructions are further executable by the processor to:
obtain an indication that the reflective surface has changed position; and
refrain from maintaining phase continuity for subsequent wireless communications between the first wireless device and one or more additional wireless devices based at least in part on obtaining the indication that the reflective surface has changed position.

24. The apparatus of claim 23, wherein the instructions are further executable by the processor to:
output, to the second wireless device, the obtained indication that the reflective surface has changed position.

25. The apparatus of claim 16, wherein the instructions are further executable by the processor to:
output, to the reflective surface, an indication that at least one of the first wireless device or the second wireless device has changed from a first position to a second position; and
refrain from maintaining phase continuity for subsequent wireless communications between the first wireless device and the second wireless device based at least in part on the indication that the at least one of the first wireless device or the second wireless device has changed from the first position to the second position.

26. The apparatus of claim 25, wherein the instructions are further executable by the processor to:
output, to the reflective surface, an indication that at least one of the first wireless device or the second wireless device has returned to the first position; and
maintain phase continuity for one or more additional wireless communications between the first wireless device and the second wireless device based at least in part on the indication that the at least one of the first wireless device or the second wireless device has returned to the first position.

27. The apparatus of claim 16, wherein the control signaling comprises a radio resource control message, a media access control (MAC) control element (MAC-CE), a downlink control information, or any combination thereof, and the first wireless device comprises a network entity and the second wireless device comprises a user equipment (UE).

28. The apparatus of claim 16, wherein the control signaling comprises a sidelink control information message, a physical sidelink shared channel message, a media access control (MAC) control element (MAC-CE), a sidelink radio resource control message, or any combination thereof, and the first wireless device comprises a first sidelink user equipment (UE) and the second wireless device comprises a second sidelink UE.

29. A method for wireless communications at a reflective surface, comprising:
transmitting capability information indicating a capability to maintain phase continuity across a plurality of transmissions according to a first set of transmission parameters;
receiving, based at least in part on the capability information, control signaling indicating one or more conditions under which the reflective surface is to maintain phase continuity; and
relaying wireless signaling between at least a first wireless device and a second wireless device according to a phase continuity condition based at least in part on the one or more conditions.

30. A method for wireless communications at a first wireless device, comprising:
obtaining, from a reflective surface, capability information indicating a capability of the reflective surface to maintain phase continuity across a plurality of transmissions according to a first set of transmission parameters;
outputting, based at least in part on the capability information, control signaling indicating one or more conditions under which the reflective surface is to maintain phase continuity; and
transmitting wireless signaling to at least a second wireless device via the reflective surface according to a phase continuity condition based at least in part on the one or more conditions.
